(19) United States
(12) Patent Application Publication
(10) Pub. No.: US 2025/0073095 A1
(43) Pub. Date: Mar. 6, 2025

(54) COT LOADING AND UNLOADING SYSTEMS HAVING A FIXED RAIL

(71) Applicant: Ferno-Washington, Inc., Wilmington, OH (US)

(72) Inventors: Gavin Broadley, Marcoola (AU); Alan Cambridge, Marcoola (AU); Richard Potts, Morrow, OH (US); Qusai F. Takruri, Dayton, OH (US); Matthew Burrell, Xenia, OH (US); Ross Kenman, Marcoola (AU); Nicholas Valentino, Springboro, OH (US); Robert Louis Potak, Medina, OH (US); Jacob L. Cartner, Clarksville, OH (US)

(73) Assignee: Ferno-Washington, Inc., Wilmington, OH (US)

(21) Appl. No.: 18/819,663

(22) Filed: Aug. 29, 2024

Related U.S. Application Data
(60) Provisional application No. 63/535,200, filed on Aug. 29, 2023.

(51) Int. Cl. A61G 3/02; B60N 3/00; B60P 1/64

(52) U.S. Cl. CPC A61G 3/0245; A61G 3/029; B60N 3/008; B60P 1/6409

(57) ABSTRACT

In one embodiment, a cot loading and unloading system includes a fixed rail having a track, wherein the fixed rail is operable to be fixed to a floor, and a carriage directly coupled to the track and operable to travel along the fixed rail on the track, wherein the carriage is further operable to travel to an extended position such that at least a portion of the carriage extends beyond a length of the fixed rail.

### CROSS-REFERENCE TO RELATED APPLICATIONS

This application claims priority to U.S. Provisional Patent Application No. 63/535,200 filed on Aug. 29, 2023 entitled “Cot Loading and Unloading Systems Having a Fixed Rail,” the entirety of which is incorporated by reference herein.

### FIELD

The present disclosure is directed to cot loading systems and, more particularly, automatic cot loading systems for automatically loading a cot into an emergency vehicle.

### BACKGROUND

Emergency cots are typically loaded into a cargo area of an emergency vehicle. However, the weight of the emergency cot and the weight of the patient it supports may put a large strain on medical personnel when lifting the cot and the patient into the emergency vehicle.

Accordingly, a need exists for mechanical cot loading systems for mechanically loading a cot and patient into the cargo area of an emergency vehicle.

### SUMMARY

In one embodiment, a cot loading and unloading system includes a fixed rail having a track, wherein the fixed rail is operable to be fixed to a floor, and a carriage directly coupled to the track and operable to travel along the fixed rail on the track, wherein the carriage is further operable to travel to an extended position such that at least a portion of the carriage extends beyond a length of the fixed rail.

In another embodiment, a fixed rail of a cot loading and unloading system having a track further includes a first side, a second side, a rack member, and a wheel guide member. The fixed rail is operable to be fixed to a floor, and the rack member has a plurality of teeth and a rack protrusion. The wheel guide member comprises a wheel guide protrusion. The rack protrusion and the wheel guide protrusion oppose one another to receive at least one wheel of a carriage and the rack protrusion and the wheel guide protrusion have a profile to mate with a groove of the at least one wheel.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a perspective view of an example cot loading and unloading system according to one or more embodiments described and illustrated herein.

FIG. 2 illustrates another perspective view of the example cot loading and unloading system of FIG. 1 according to one or more embodiments described and illustrated herein.

FIG. 3 illustrates a top view of the example cot loading and unloading system of FIG. 1 according to one or more embodiments described and illustrated herein.

FIG. 4 illustrates a side view of the example cot loading and unloading system of FIG. 1 according to one or more embodiments described and illustrated herein.

FIG. 5 illustrates a front view of the example cot loading and unloading system of FIG. 1 according to one or more embodiments described and illustrated herein.

FIG. 6A illustrates a rear view of the example cot loading and unloading system of FIG. 1 with a carriage cover removed according to one or more embodiments described and illustrated herein.

FIG. 6B illustrates a close-up perspective view of the example cot loading and unloading system of FIG. 1 according to one or more embodiments described and illustrated herein.

FIG. 7A illustrates a perspective view an example fixed rail with a support beam extended according to one or more embodiments described and illustrated here.

FIG. 7B illustrates a top view of the example fixed rail of FIG. 7A according to one or more embodiments described and illustrated herein.

FIG. 7C illustrates a perspective view of an example support beam according to one or more embodiment described and illustrated herein.

FIG. 7D illustrates a close-up perspective view of the fixed rail of FIG. 7A with a top cover of a removable section removed according to one or more embodiments described and illustrated herein.

FIG. 7E illustrates locking components of a fixed rail and a removable section according to one or more embodiments described and illustrated herein.

FIG. 7F illustrates a perspective view of a removable section removed from the fixed rail of FIG. 7A according to one or more embodiments described and illustrated herein.

FIG. 7G is a perspective view of support beam locking features according to one or more embodiments described and illustrated herein.

FIG. 7H illustrates a lock groove 196 of a fixed rail for receiving a removable section or a fixed rail according to one or more embodiments described and illustrated herein.

FIG. 7I illustrates a perspective view of a carriage having a locking block according to one or more embodiments described and illustrated herein.

FIG. 7J illustrates another view of the support beam locking features of FIG. 7G according to one or more embodiments described and illustrated herein.

FIG. 7K illustrates various components of the support beam locking features of FIG. 7J according to one or more embodiments described and illustrated herein.

FIG. 7L illustrates a perspective view of a support beam and an end roller support section of a fixed rail according to one or more embodiments described and illustrated herein.

FIG. 7M illustrates a perspective view of an end roller support section according to one or more embodiments described and illustrated herein.

FIG. 7N illustrates a perspective view of a head-end roller assembly according to one or more embodiments described and illustrated herein.

FIG. 7O illustrates a perspective view of ramp blocks of a fixed rail according to one or more embodiments described and illustrated herein.

FIG. 7P illustrates a perspective view of an individual ramp block of FIG. 7O according to one or more embodiments described and illustrated herein.

FIG. 8 illustrates a perspective view of a fastener receiver of a fixed rail according to one or more embodiments described and illustrated herein.

FIG. 9 illustrates a rear perspective view of a fixed rail according to one or more embodiments described and illustrated herein.

FIG. 10 illustrates another rear perspective rear view of the fixed rail of FIG. 9 according to one or more embodiments described and illustrated herein.

FIG. 11A illustrates a rear perspective view of a carriage according to one or more embodiments described and illustrated herein.

FIG. 11B illustrates a perspective view of components for operating a carriage lock lever according to one or more embodiments described and illustrated herein.

FIG. 11C illustrates a close-up view of operation of the carriage lock lever of FIG. 11B according to one or more embodiments described and illustrated herein.

FIG. 11D illustrates a close-up view of an arcuate slot and pin for operating the carriage lock lever of FIG. 11B according to one or more embodiments described and illustrated herein.

FIG. 11E illustrates a perspective view of components for operating the carriage lock lever as shown in FIG. 11B with load arms in a raised position according to one or more embodiments described and illustrated herein.

FIG. 11F illustrates a perspective view of the carriage showing components for operating the carriage lock lever shown in FIG. 11B according to one or more embodiments described and illustrated herein.

FIG. 12A illustrates a side view of a carriage showing a drive motor and related components according to one or more embodiments described and illustrated herein.

FIG. 12B illustrates a perspective view of a drive motor, a motor pinion and a drive pinion according to one or more embodiments described and illustrated herein.

FIG. 12C illustrates a close-up perspective view of a carriage showing a carriage position switch according to one or more embodiments described and illustrated herein.

FIG. 12D illustrates a close-up, rear, perspective view of a carriage showing a power drive release lever in an engaged state according to one or more embodiments described and illustrated herein.

FIG. 12E illustrates a close-up, rear, perspective view of the carriage and power drive release lever of FIG. 12D in a disengaged state according to one or more embodiments described and illustrated herein.

FIG. 13A illustrates a side view of a carriage showing components of a latch mechanism for latching a cot to the carriage according to one or more embodiments described and illustrated herein.

FIG. 13B illustrates a perspective view of the carriage showing components of a latch mechanism of FIG. 13A according to one or more embodiments described and illustrated herein.

FIG. 13C illustrates another perspective view of the carriage of FIG. 13A showing components to prevent actuation of the latch mechanisms according to one or more embodiments described and illustrated herein.

FIG. 13D illustrates another view of the carriage of FIG. 13A showing components to prevent actuation of the latch mechanisms according to one or more embodiments described and illustrated herein.

FIG. 13E illustrates another view of the carriage of FIG. 13A showing components to prevent actuation of the latch mechanisms according to one or more embodiments described and illustrated herein.

FIG. 13F illustrate a perspective view of an override button and associated component to allow activation of the latch mechanisms according to one or more embodiments described and illustrated herein.

FIG. 13G illustrates a perspective view of the carriage of FIG. 13A showing additional components for actuating the latch mechanisms according to one or more embodiments described and illustrated herein.

FIG. 13H illustrates a perspective view of a fixed rail and a carriage showing a switch plate for selectively actuating various latches according to one or more embodiments described and illustrated herein.

FIG. 13I illustrates a perspective view of the fixed rail of FIG. 13H showing linkages for selectively actuating various latches according to one or more embodiments described and illustrated herein.

FIG. 13J illustrates a perspective view of linkages and a flip-flop tab for activing the linkages according to one or more embodiments described and illustrated herein.

FIG. 13K illustrates a cutaway perspective view of a fixed rail and support beam showing components for manipulating the flip-flop tab of FIG. 13J according to one or more embodiments described and illustrated herein.

FIG. 13L illustrates another perspective view of the support beam showing components for manipulating the flip-flop tab of FIG. 13J according to one or more embodiments described and illustrated herein.

FIG. 13M illustrates a bottom view of the switch plate and linkages of FIG. 13H operating in a first mode according to one or more embodiments described and illustrated herein.

FIG. 13N illustrates a perspective view of the switch plate being activated in the first mode according to one or more embodiments described and illustrated herein.

FIG. 13O illustrates a perspective view of a fixed rail and support beam entering an over-the-top manual mode according to one or more embodiments described and illustrated herein.

FIG. 13P illustrates a bottom view of the switch plate and linkages of FIG. 13H operating in a second mode according to one or more embodiments described and illustrated herein.

FIG. 13Q illustrates a perspective view of the switch plate being activated in the second mode according to one or more embodiments described and illustrated herein.

FIG. 13R illustrates another perspective view of the switch plate according to one or more embodiments described and illustrated herein.

FIG. 13S illustrates a perspective view of a carriage lock assembly according to one or more embodiments described and illustrated herein.

FIG. 13T illustrates a bottom view of a carriage according to one or more embodiments described and illustrated herein.

FIG. 13U illustrates latch components of a fastener receiver according to one or more embodiments described and illustrated herein.

FIG. 14 illustrates a perspective view of a spare battery container according to one or more embodiments described and illustrated herein.

FIGS. 15A-15F illustrate various stages of operation of an example cot loading and unloading system according to one or more embodiments described and illustrated herein.

FIGS. 16A-16D illustrate an ultrasonic sensor on a cot for pairing a cot with a master control device with the load arms in various positions according to one or more embodiments described and illustrated herein.

### DETAILED DESCRIPTION

Reference will now be made in detail to the embodiments of the disclosure, examples of which are illustrated in the accompanying drawings. Whenever possible, like reference numbers will be used to refer to like components or parts.

Embodiments of the present disclosure are directed to cot loading systems that automatically lift and load a cot into a cargo area of an emergency vehicle, and automatically unload and lower a cot onto the ground surface from a cargo area of an emergency vehicle. The automatic lifting and lower of the cot and the patient it supports reduces strain on medical personnel, thereby preventing injury. More particularly, the cot loading systems described herein comprise a fixed rail that is mounted to the floor of a cargo area of a vehicle, such as an ambulance. A carriage is operable to automatically traverse back and forth along the fixed rail. A support beam within the fixed rail enables the carriage to traverse beyond the end of the fixed rail. Load arms are provided to lift and lower the cot during loading and unloading sequences. A master control device is provided as a primary controller to both the components of the cot loading system and the cot.

Various embodiments of cot loading and unloading systems are described in detail below.

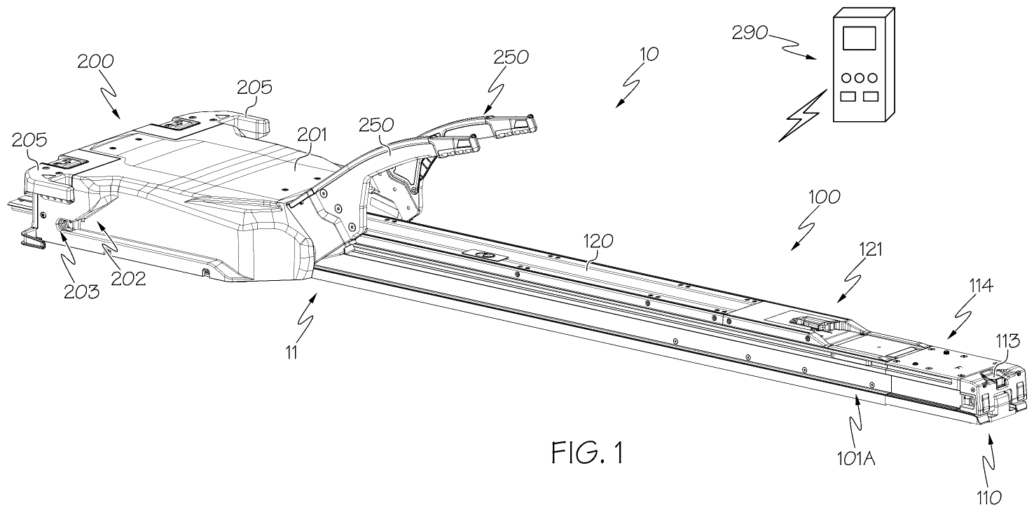

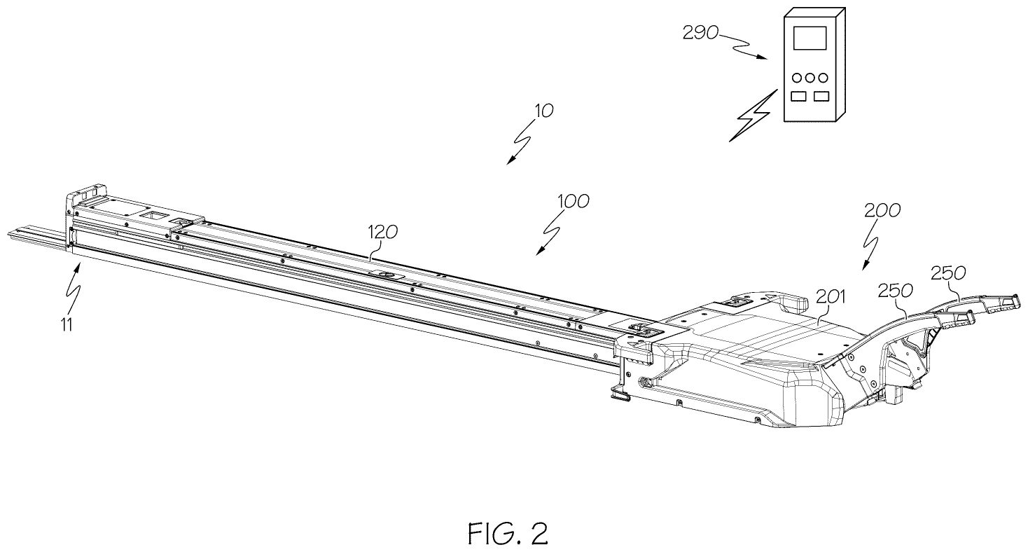

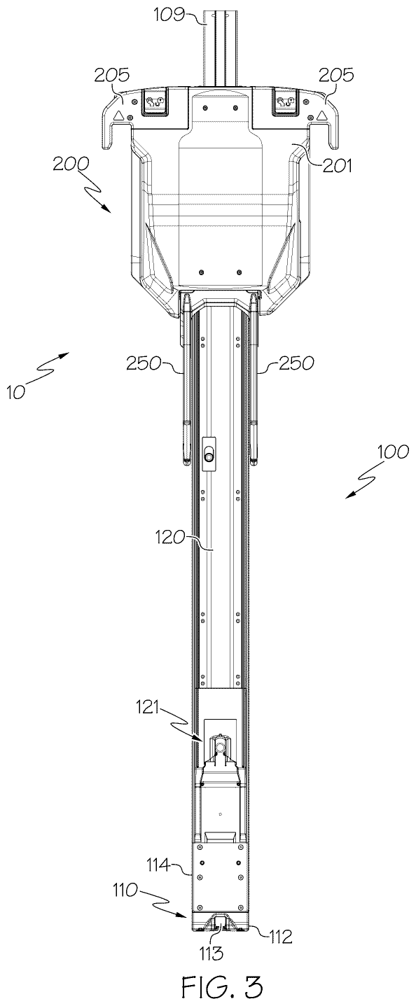

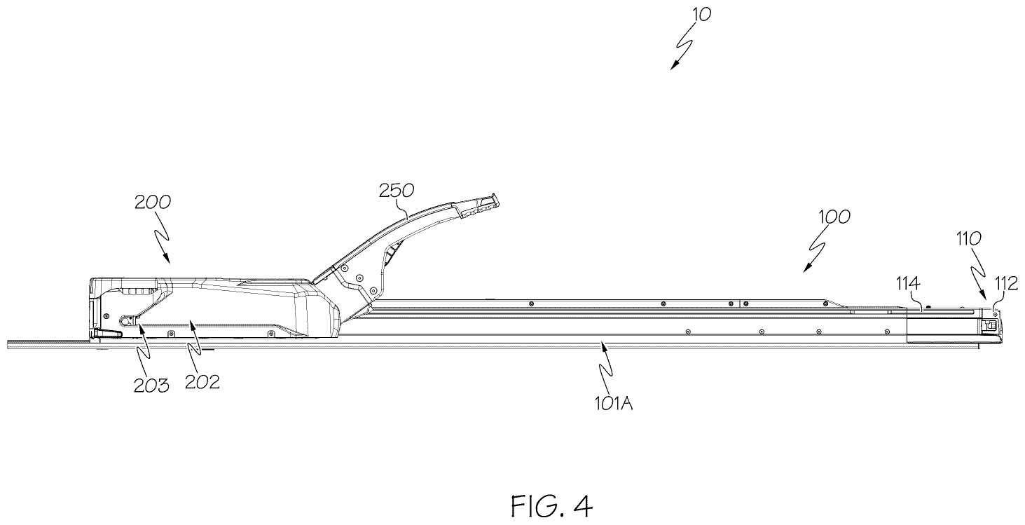

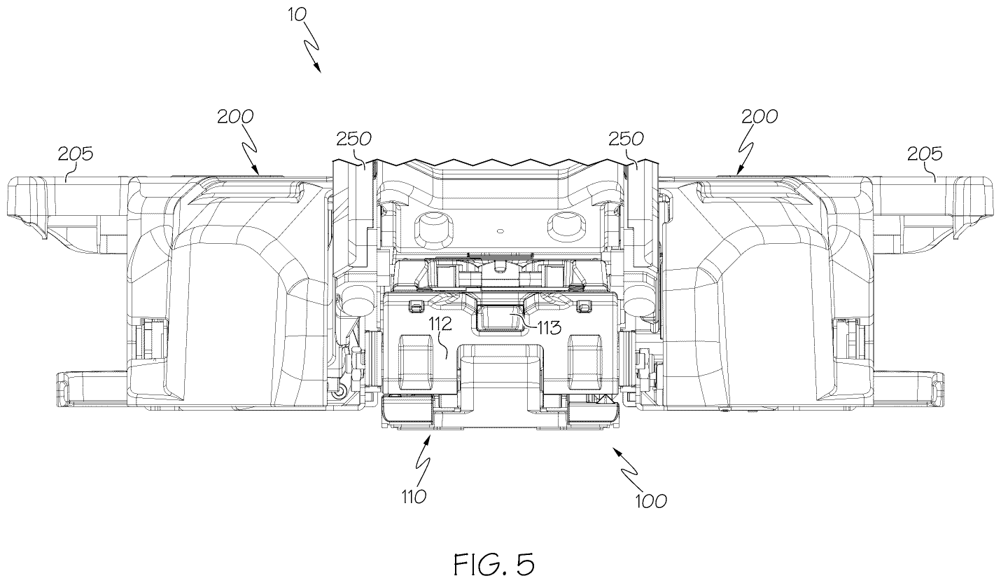

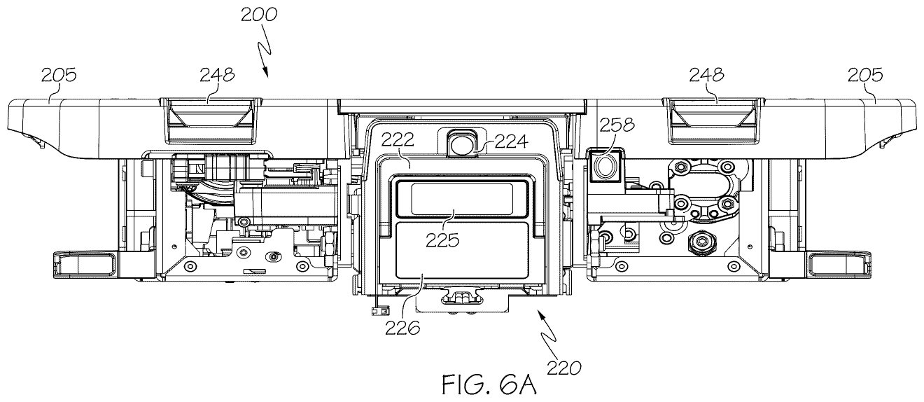

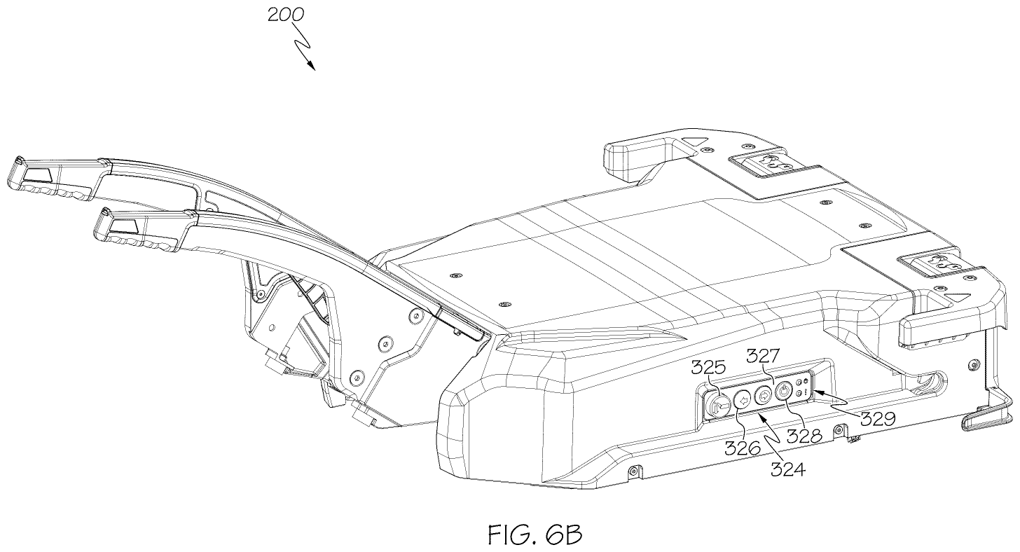

Referring now to FIGS. 1-6B, an example cot loading and unloading system 10 is schematically illustrated. FIG. 1 is a perspective view of the cot loading and unloading system 10 in a retracted position, and FIG. 2 illustrates the cot loading and unloading system 10 in an extended state that is ready to receive an emergency cot. FIG. 3 is a top view of the of the cot loading and unloading system 10, FIG. 4 is a side view of the cot loading and unloading system 10, FIG. 5 is a front view of the cot loading and unloading system 10, and FIG. 6A is a back view of the cot loading and unloading system 10 with rear cover components removed. FIG. 6B illustrates a close-up side view of a carriage having an interface 324.

The cot loading and unloading system 10 generally comprise a track assembly 100 that is operable to be mounted to the floor of the cargo area of an emergency vehicle, such as an ambulance (not shown), and a carriage 200 that is operable to translate back and forth on the track assembly 100. The track assembly 100 comprises a fixed rail 120 that is fixed relative to the floor of the cargo area by way of a mount 109. The mount 109 is directly affixed to the floor, and the track assembly 100 is affixed to the mount 109. In other embodiments, the track assembly 100 is directly affixed to the floor rather than to a mount. “Fixed” means that the fixed rail 120 does not move relative to the floor of the cargo area. Only the carriage 200 and the support beam 110 translates relative to the floor of the cargo area. “Directly fixed” also includes intermediate components, such as trays, inserts, mounts, and the like.

As described in more detail below, the carriage 200 includes a housing 201 and two load arms 250 operable to pivot up to lift an emergency cot when loading the emergency cot into the cargo area, and pivot down to lower the emergency cot when unloading the emergency cot. The housing 201 further includes two sides, each having a guide portion 202 that is operable to guide a load wheel pin (not shown) of a cot into a latch region 203 when the cot is being loaded into the cot loading and unloading system 10. The housing further includes antlers 205 that are shaped as hooks that are operable to receive an end of the cot when it is fully positioned within the carriage 200. In some embodiments, lights are positioned on the underside of the housing 201 to illuminate the ground beneath the carriage 200 when it is in an extended position.

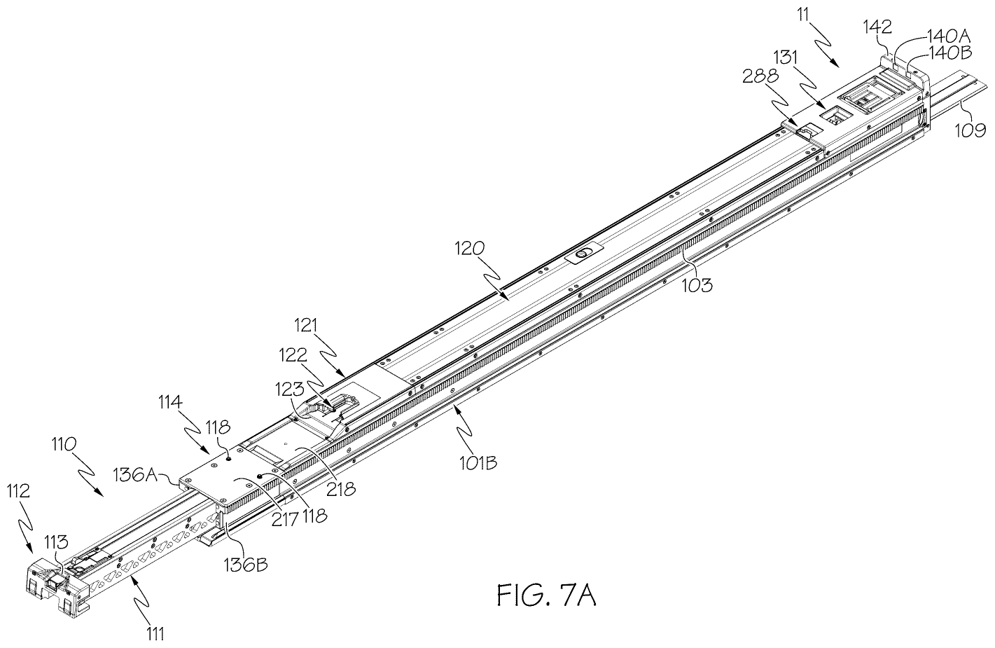

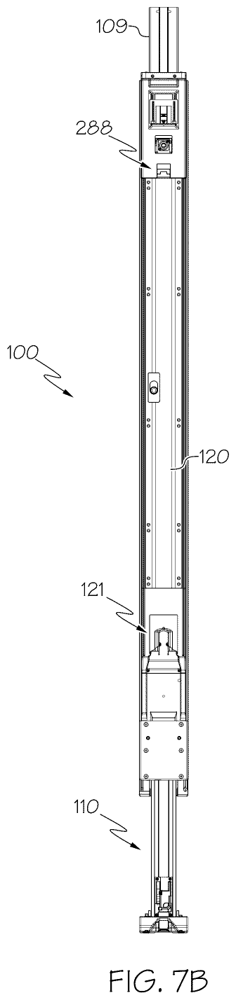

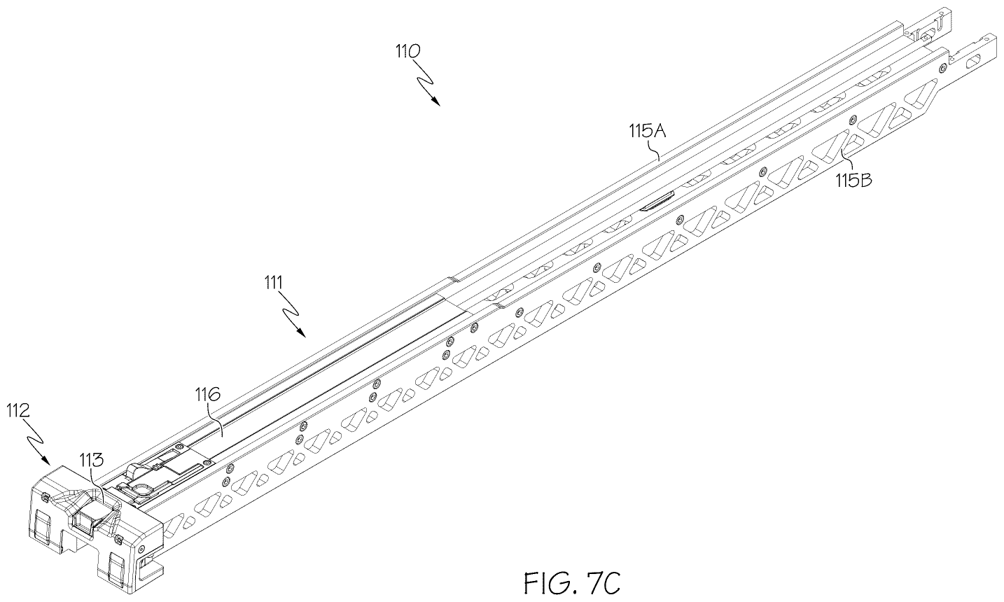

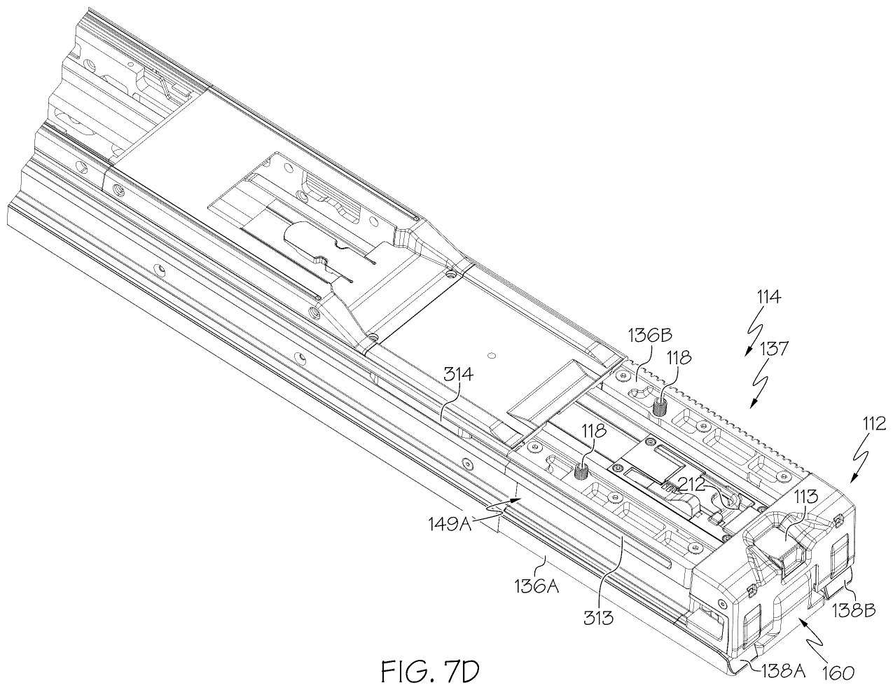

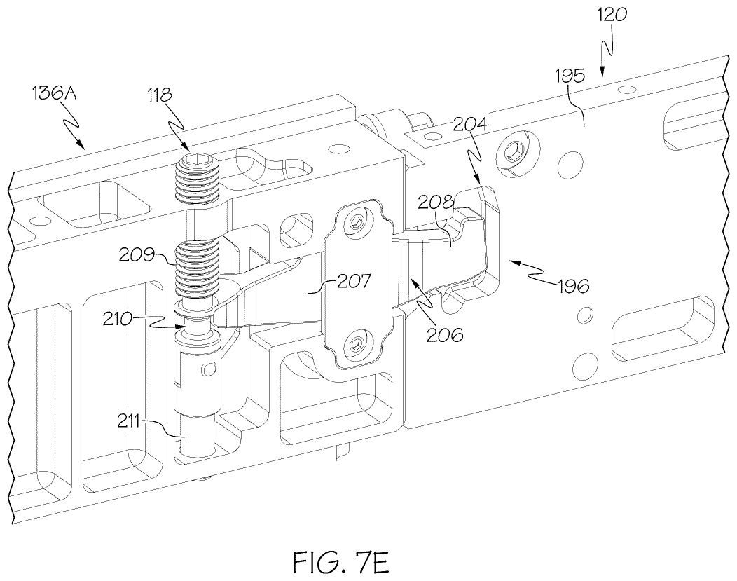

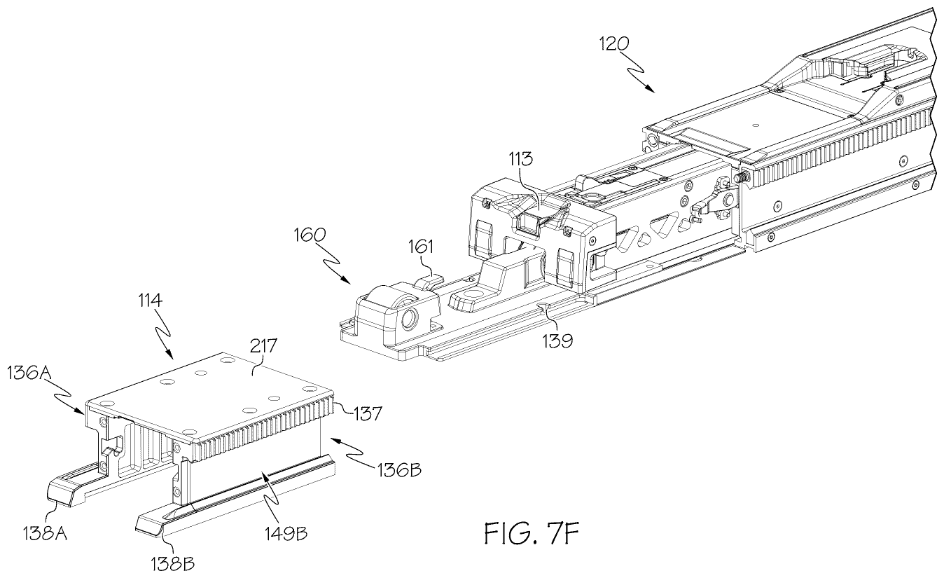

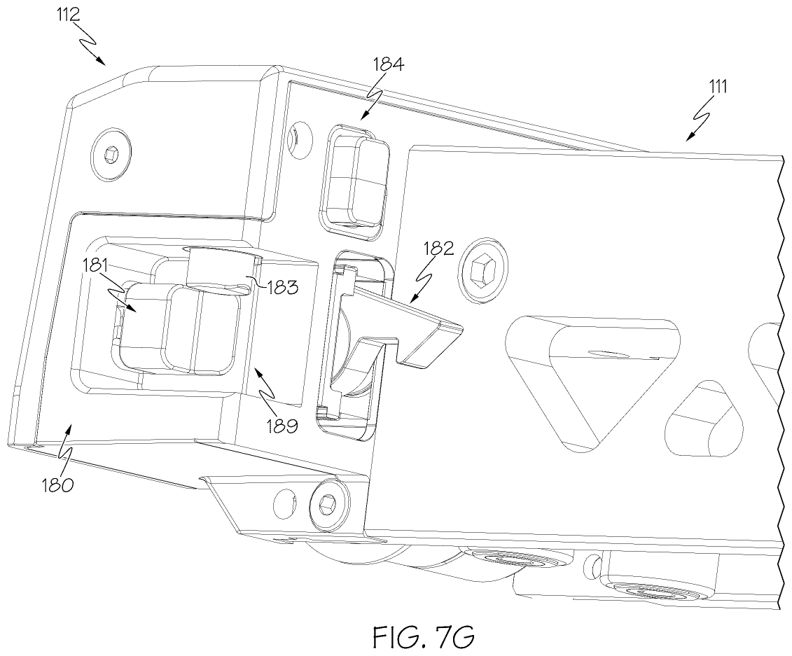

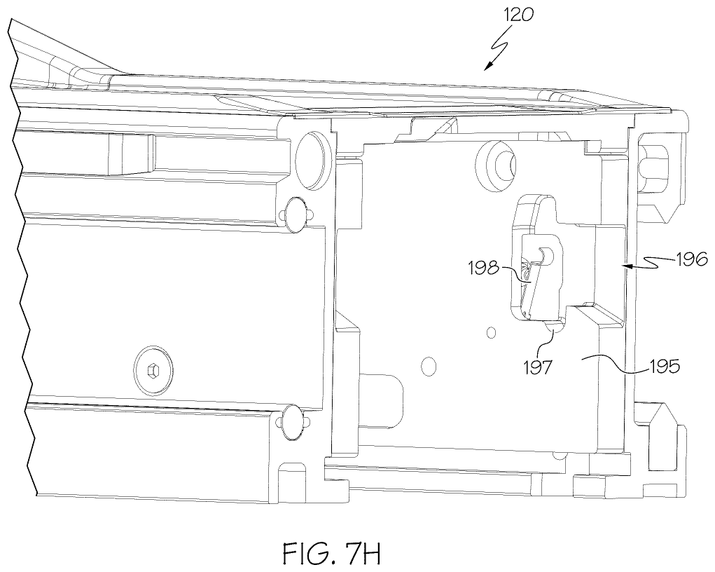

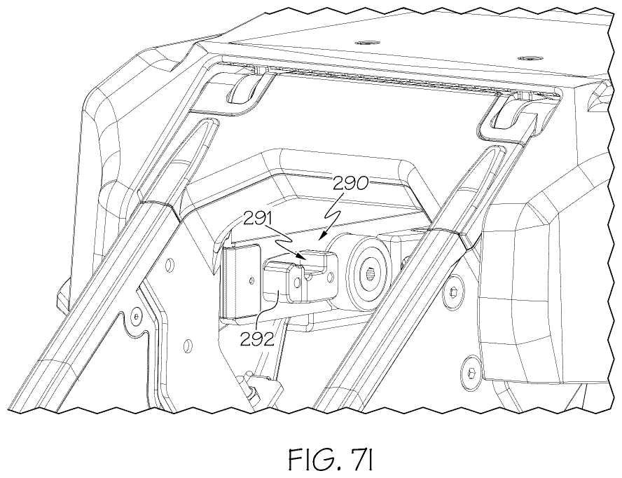

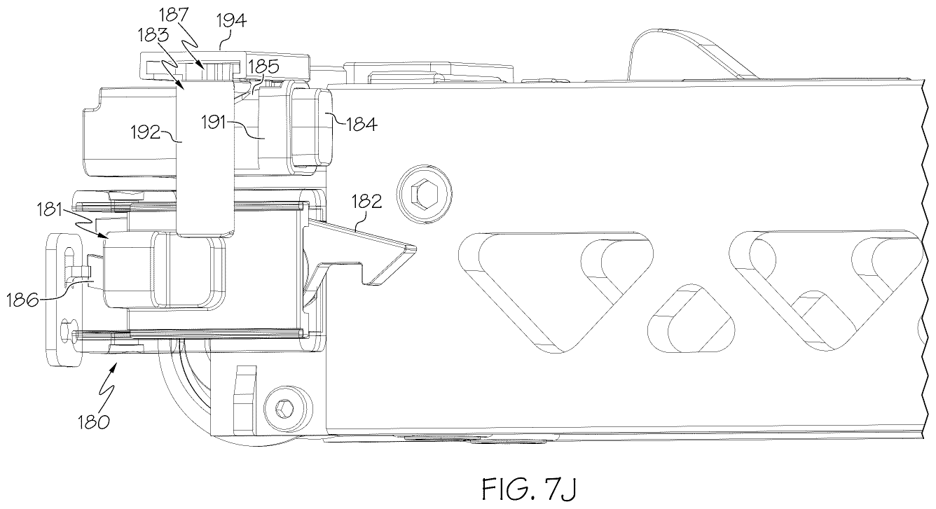

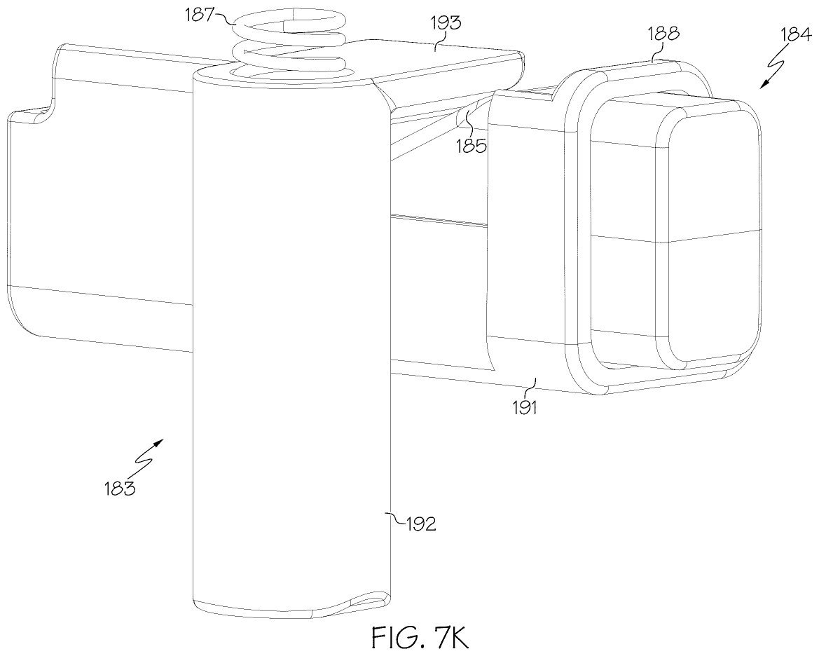

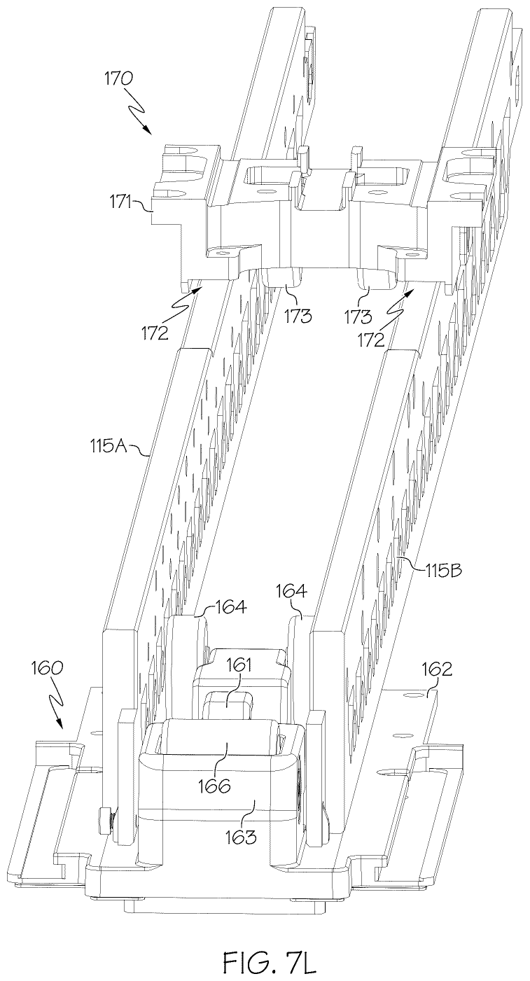

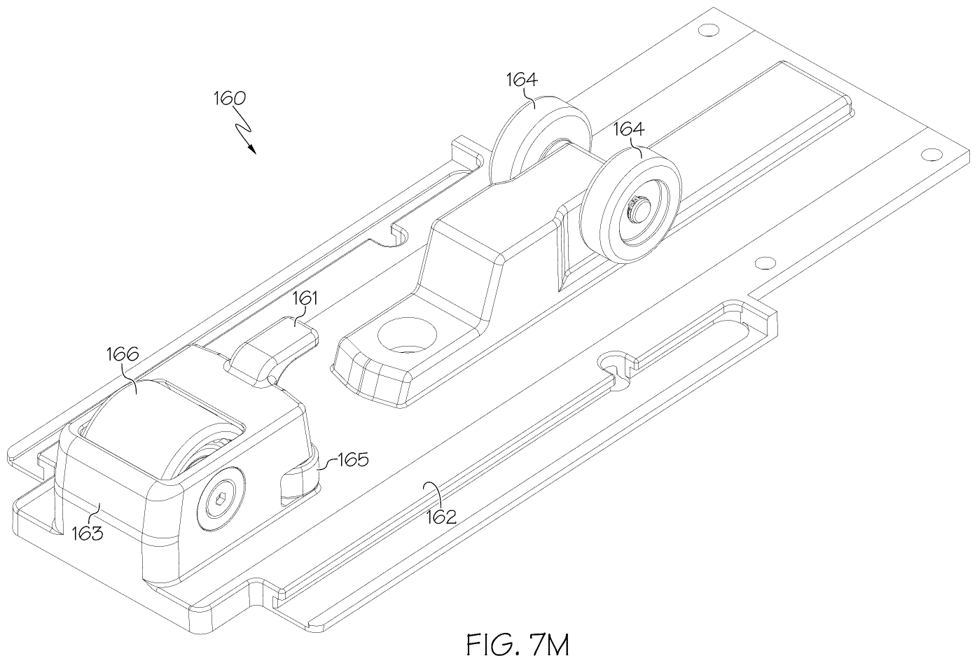

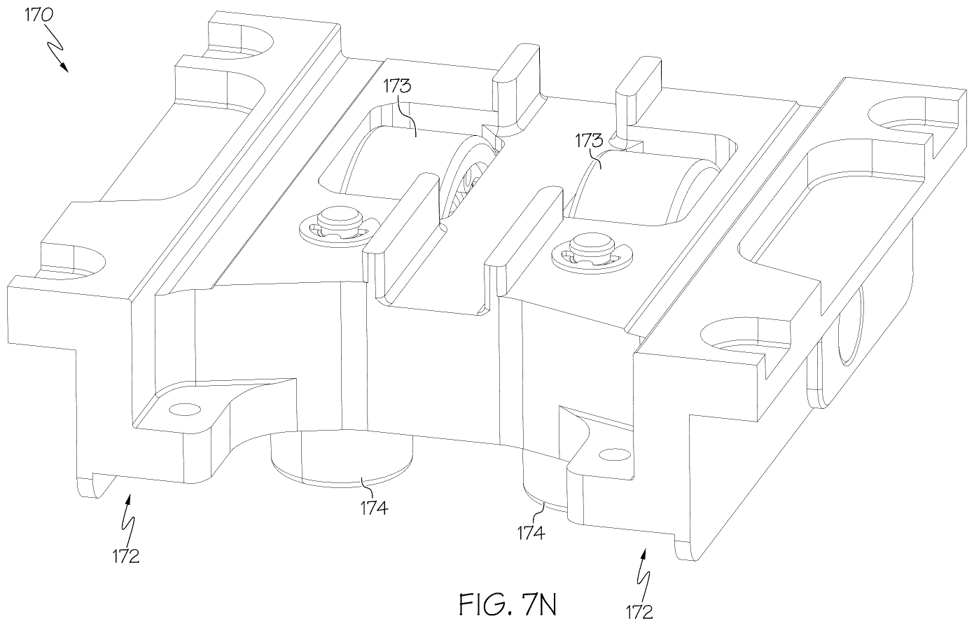

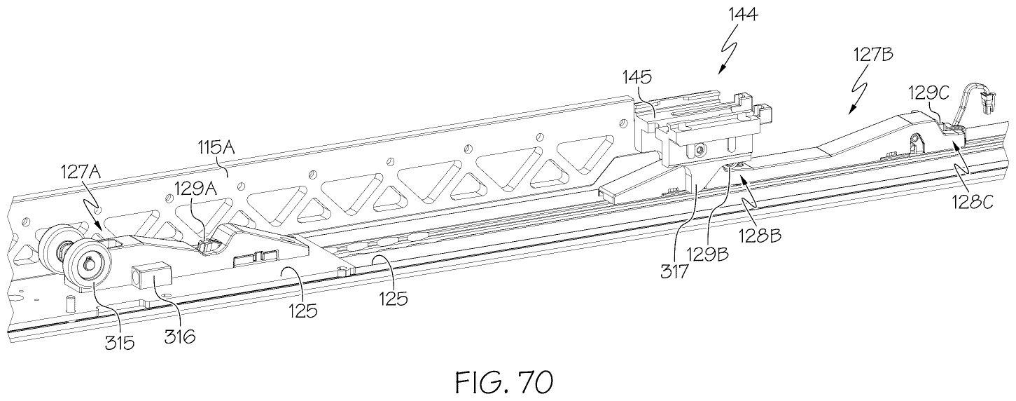

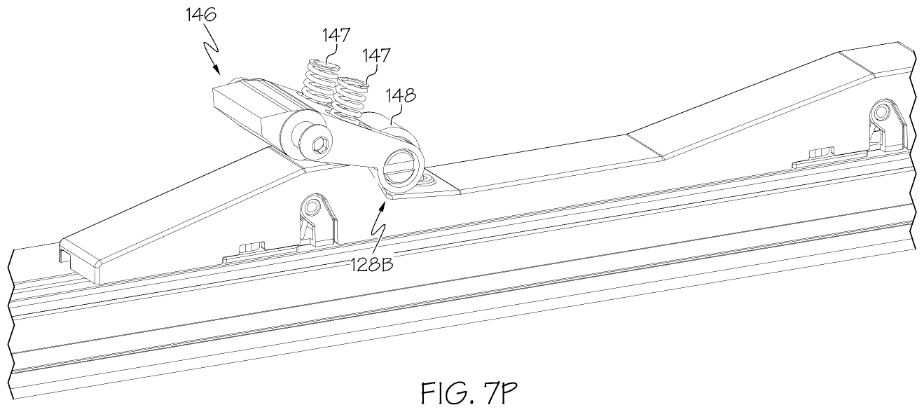

In the extended position as shown in FIG. 2, the a portion of the carriage 200 (e.g., a majority) is capable of extending beyond the cargo area of the emergency vehicle. FIGS. 7A and 7B illustrate a track assembly 100 that includes the fixed rail 120 as well as a support beam 110 that is nested within a passageway defined by the fixed rail 120. FIG. 7C is a perspective view of the support beam 110 in isolation. The support beam 110 is operable to move in and out of the fixed rail 120 along a longitudinal axis of the track assembly 100. FIGS. 7A and 7B illustrate the support beam 110 in an extended position. The support beam 110 supports the carriage 200 when it is in an extended position. In this manner, a foot-end of the carriage 200 can translate beyond the end of the fixed rail 120.

The example support beam 110 generally comprises a U-shaped support beam member 111 and an end block 112. The U-shaped support beam member 111 may be defined by a first support beam member side 115A, a second support beam member side 115B, and one or more top plates 116, or as a single, monolithic component in other embodiments. As described in more detail below, one or more rollers are disposed within the fixed rail 120 to allow the support beam 110 to translate within a passageway of the fixed rail 120.

The support beam 110 further includes an release button 113 that allows a user to unlock the cot from a fastener receiver 121 as described in more detail below, as well as unlock the carriage 200 from the head-end 129 of the fixed rail 120, so that the cot may be translated out of the cargo area.

As described in more detail below, during a load operation, the carriage 200 automatically moves toward the foot-end of the fixed rail 120. In some embodiments, the carriage 200 is manually moved to the foot-end of the fixed rail 120 by an operator. In other embodiments, the system is equipped with a power drive that automatically moves the carriage 200 to the foot-end of the fixed rail 120 upon activation of a control button. The front of the carriage 200 contacts the end block 112 of the support beam 110, which pushes the support beam out of the fixed rail 120 such that it may support the carriage 200 in the extended position.

During normal, automatic operation, the carriage 200 moves to the foot-end of the fixed rail 120. However, in some cases a user may have a need to load a cot into the cot loading and unloading system 10 in an over the top manual mode that accommodates any type of cot that fits over the carriage 200 and within the antlers 205. In embodiments, the cot loading and unloading system 10 is convertible between an automatic mode and the over the top manual mode. In the over the top manual mode, the carriage 200 remains at the head-end 129 of the fixed rail 120.

Referring to FIG. 6B, the carriage 200 may include an interface 324 having buttons to perform various functions, such as a load arm button 325 to control the load arms 250, a left arrow button 326 (also referred to as a minus (−) button) to move the carriage 200 out on the fixed rail 120, a right arrow (also referred to as a plus (+) button) to move the carriage 200 back into a cargo area on the fixed rail 120, and a power button 328. The interface 324 may also include lights to show that status of the cot loading and unloading system 10, such as power on and error codes.

Referring once again to FIG. 7A, the fixed rail 120 of the illustrated embodiment includes a removable section 114. The removable section 114 extends the length of the fixed rail 120 and thus extends the length that the carriage 200 travels on the fixed rail 120. The removable section 114 is fastened to the fixed rail 120 during normal operation when the carriage 200 is mechanically driven by the power drive (i.e., the drive motor 230).

The removable section 114 generally includes a first removable side plate 136A, a second removable side plate 136B, a top plate 217 and removable section fastening mechanisms 118. The second removable side plate 136B includes a rack member 137 having teeth that is in-line with the grooved rack member 103 of the fixed rail 120. Thus, the removable section 114 extends the total length of the rack that the carriage 200 travels along using the drive motor 230.

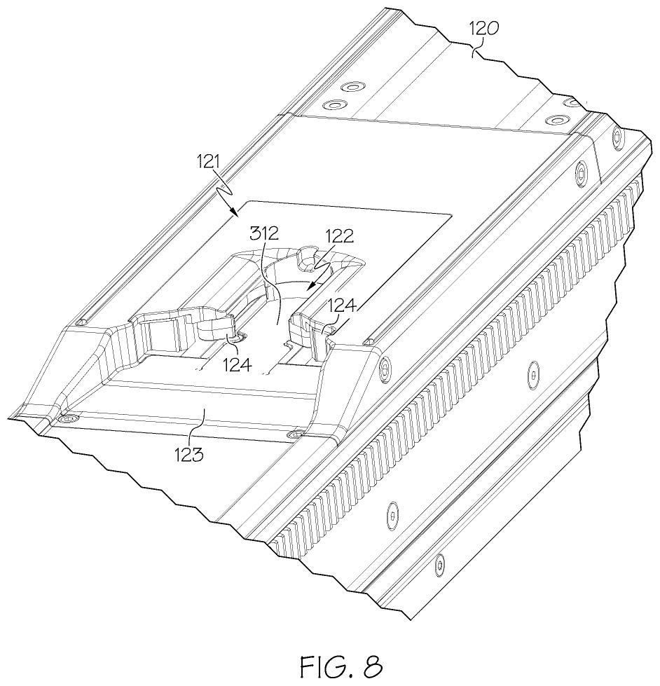

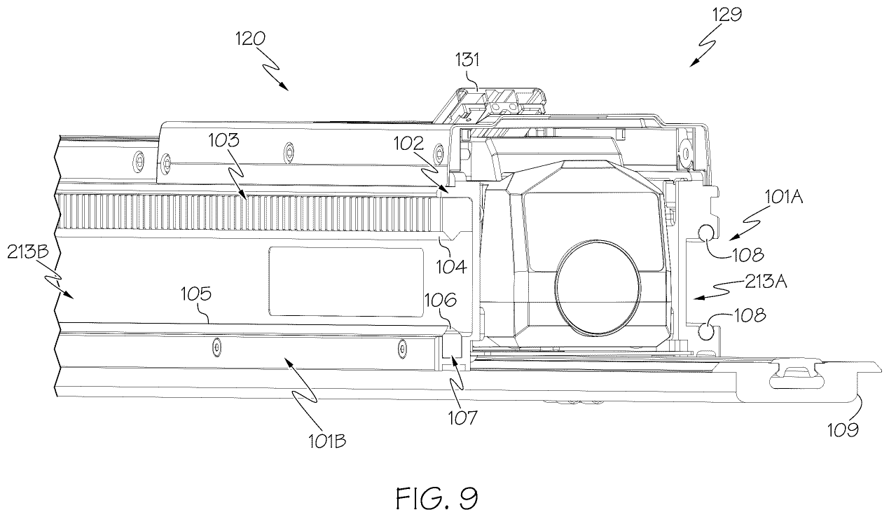

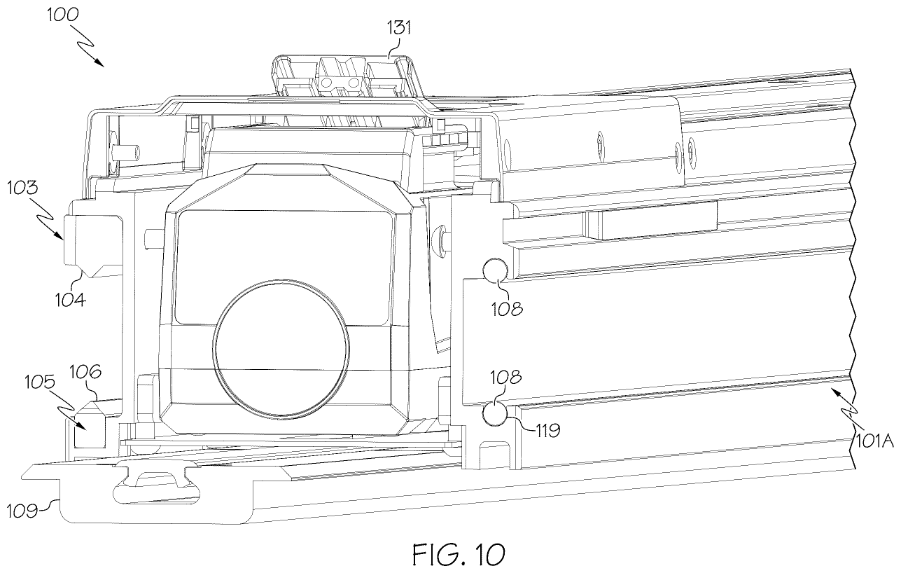

The removable section 114 also includes a first wheel recess 149A and a second wheel recess 149B (see FIGS. 7D and 7F) for receiving the wheels of the carriage 200 to further continue the track of the fixed rail 120. The removable section 114 also includes the same wheel guide features of the fixed rail, including the groove rack member 103 with a downward-facing V-shaped protrusion and a wheel guide member 105 operable to guide the wheels of the carriage 200, as described in more detail below with respect to FIGS. 9 and 10.

In addition to the normal, automatic mode whereby the carriage is mechanically driven by the drive motor 230, the cot loading and unloading system 10 can operate in a manual mode whereby a user pushes and pulls the carriage 200 across the fixed rail 120 without motor assist. Such a manual mode may be utilized if the cot loading and unloading system 10 is not equipped with a power drive, for example.

There is also an over-the-top manual mode whereby the carriage 200 remains at the head-end of the fixed rail 120 and the user loads and pushes the cot on the fixed rail 120 toward the carriage 200.

The cot loading and unloading system 10 is changed from the normal, automatic mode to the over-the-top manual mode by removing the removable section 114 from the fixed rail 120. With no cot engaged with the cot loading and unloading system 10, the carriage 200 is moved to the head-end 129 of the fixed rail 120, and is locked to the fixed rail 120 with the load arms lowered, as is shown in FIG. 1. The user then extends the support beam 110 by pressing on the actuation buttons 181 in the end block 112 which unlocks the support beam 110 from the fixed rail (see FIG. 7G). The user then extends the support beam 110 out of the fixed rail 120, as shown in FIGS. 7A and 7B.

FIG. 7D illustrates the top plate 217 of the removable section 114 having been removed. However, the top plate 217 does not need to be removed to remove the removable section 114. It is noted that FIG. 7D illustrates the end block 112 of the support beam 110 still engaged with the removable section 114; however, in practice the end block 112 and the support beam 110 are pulled away from the removable section 114 to provide clearance to remove the removable section 114 from the fixed rail 120. It is further noted that the first removable side plate 136A and the second removable side plate 136B include a first removable extension arm 138A and a second removable extension arm 138B, respectively, which receive the wheels of the carriage 200. As the carriage 200 is extended, the foot-end wheels of the carriage roll of the first removable extension arm 138A and the second removable extension arm 138B. The ends of the first removable extension arm 138A and the second removable extension arm 138B are tapered to aid the foot-end carriage wheels in transitioning back onto the fixed rail 120.

In the illustrated embodiment, the support beam 110 stores a tool 212 (e.g., an Allen key) that is used to release a removable section fastening mechanisms to unlatch the removable section 114 from the fixed rail 120. In other embodiments a tool 212 is not provided. The removable section fastening mechanisms of the illustrated embodiment include pins 118 (FIG. 7D) and fixed rail latches 206. A pin 118 and a fixed rail latch 206 is associated with each of the first removable side plate 136A and the second removable side plate 136B.

FIG. 7E illustrates a pin 118 and a fixed rail latch 206 of the first removable side plate 136A. It should be understood that the second removable side plate 136B has a similar pin 118 and fixed rail latch 206. The pin 118 has a threaded portion 209, a center portion 210, and a lock portion 211. The threaded portion 209 is disposed within a threaded hole of an upper portion of the first removable side plate 136A. The threaded portion 209 is therefore threadedly engaged with the first removable side plate 136A.

The fixed rail latch 206 has a latch arm 208 and an actuation arm 207. The fixed rail latch 206 is pivotably coupled to the first removable side plate 136A. The actuation arm 207 is coupled to the center portion 210 of the pin, and the latch arm 208 is operable to be disposed within a lock groove 196 of a side block 195 of the fixed rail 120. The lock groove 196 includes a removable section lock notch 204 for receiving the hooked end of the latch arm 208. When the removable section 114 is fastened to the fixed rail 120, and the threaded portion 209 of the pin 118 is fully tightened with respect to the first removable side plate 136A, the center portion 210 of the pin pivots the actuation arm 207 downward, which pivots the latch arm 208 upward so that the hooked end is positioned within the removable section lock notch 204. In this state, the latch arm 208 prevents the removable section 114 from being pulled away from the fixed rail 120.

Additionally, the lock portion 211 is lowered beyond a bottom edge of the first removable side plate 136A when the pin 118 is fully tightened with respect to the first removable side plate 136A. In this state, the bottom of lock portion 211 is disposed within a pin hole 139 of an end roller support section 160 of the fixed rail 120. The location of the lock portion 211 of each pin 118 within their respective pin holes 139 of the end roller support section 160 further limited lateral movement of the removable section 114 with respect to the fixed rail 120.

To remove the removable section 114, the user uses the tool 212 (e.g., an Allen key) to unwind and loosen the pins 118, which causes the pins 118 to raise. Referring to FIG. 7E, the raising of the pin 118 causes the center portion 210 to raise, which pivots the actuation arm 207 upward, which in turn pivots the latch arm 208 downward. Further, loosening the pins 118 cause the lock portions 211 to be raised out of the their respective pin holes 139. The removable section 114 is unlocked from the fixed rail 120 when the pins 118 are fully unloosened.

Once unlocked, the removable section 114 is pulled away from the support beam member 111, as shown in FIG. 7F. A removable section switch (not shown) positioned within the fixed rail 120 is triggered to signal that the removable section 114 is not fixed securely to the fixed rail 120, thereby disabling the drive motor 230 of the carriage 200.

The support beam 110 is then pushed back into the passageway of the fixed rail 120. There is a switch (not shown) that is positioned in the fixed rail 120 that is capable of detecting that the support beam 110 is positioned closer to the head-end of the fixed rail 120 than during normal operation, which sets the cot loading and unloading system 10 into the over-the-top manual mode. Pushing the support beam 110 into the fixed rail 120 as shown in FIG. 7F exposes the end roller support section 160 of the fixed rail 120, which includes a safety hook 161 that is used to engage with a bail bar of a cot. The safety hook 161 provides a capture point for the cot via the bail bar, and prevents the cot from rolling off the back of the ambulance when the operators are collapsing the legs to load the cot. The safety hook 161 is also used for unloading the cot to the same effect. Once the support beam 110 is locked to the fixed rail 120, the system is then ready to load a cot manually.

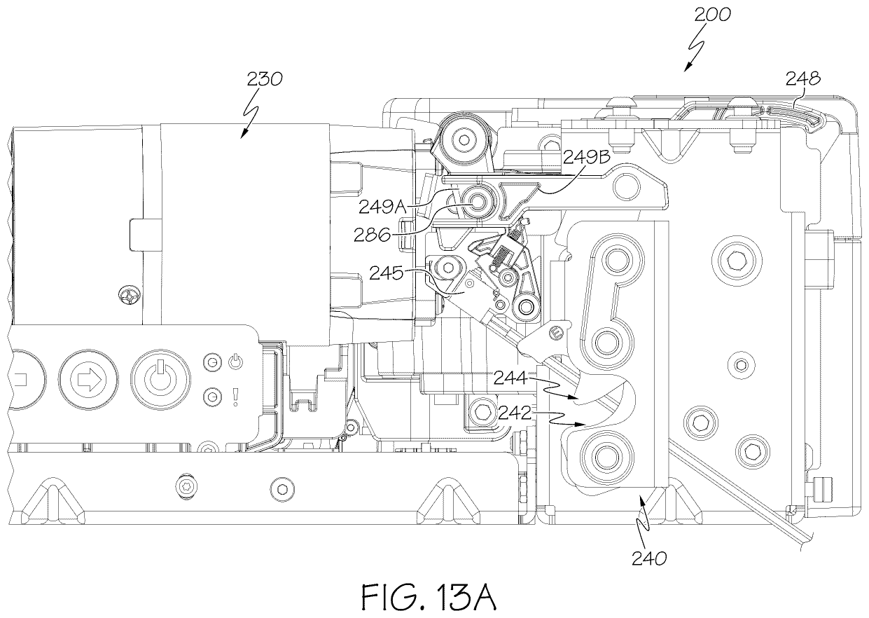

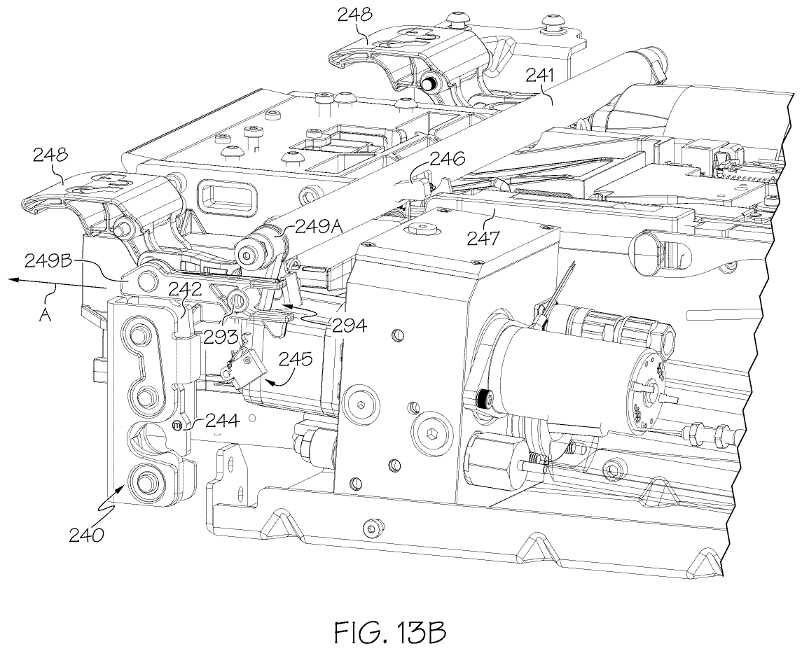

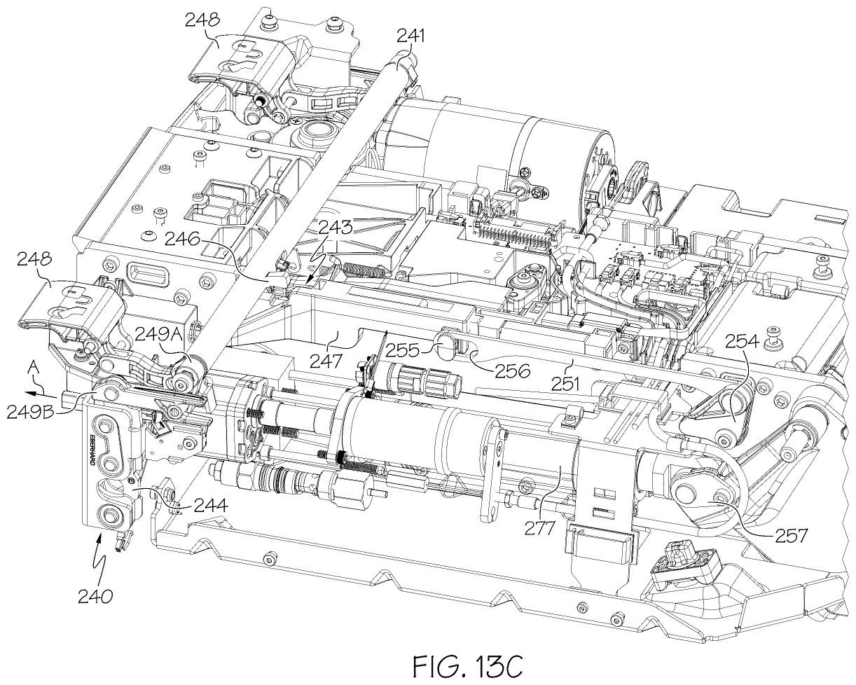

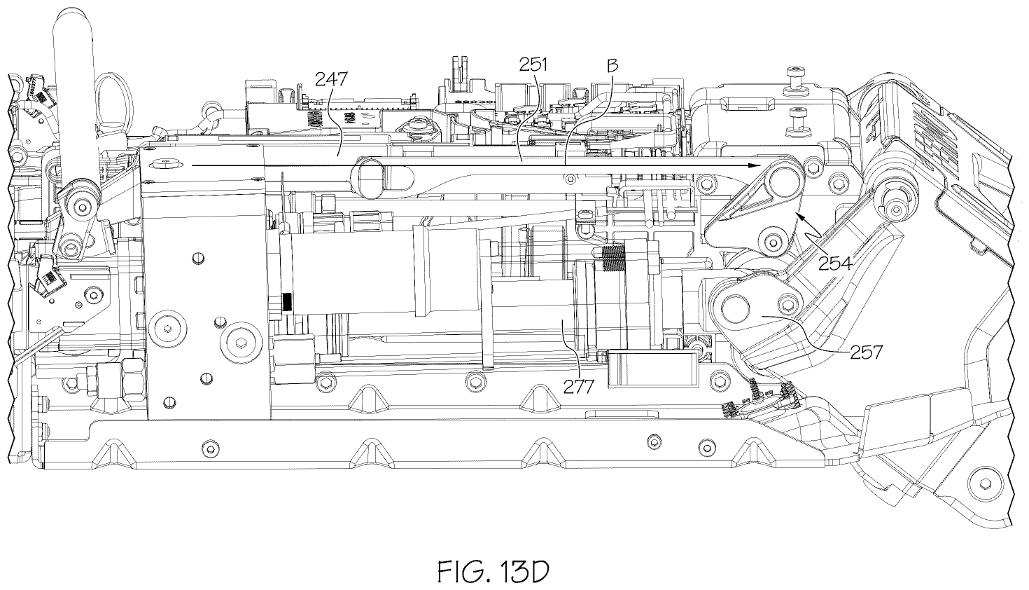

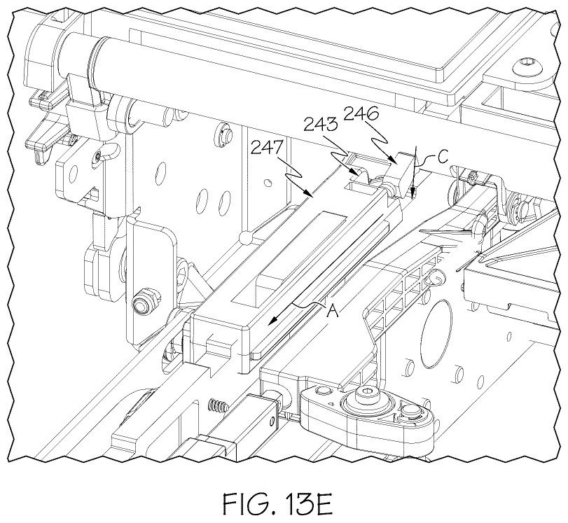

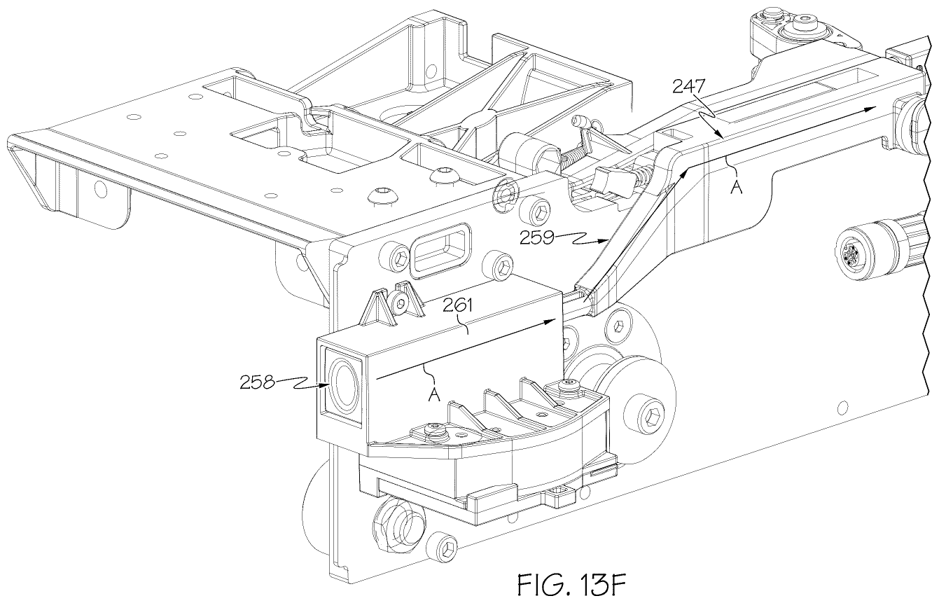

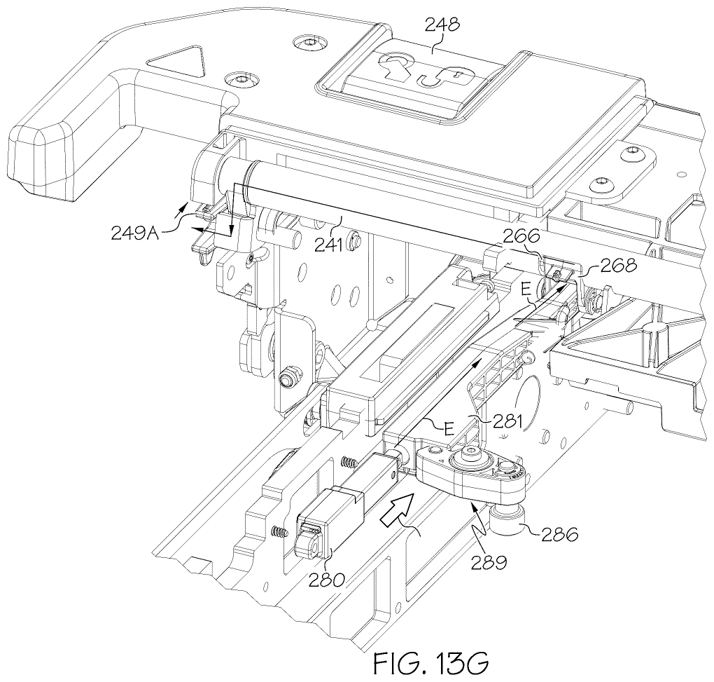

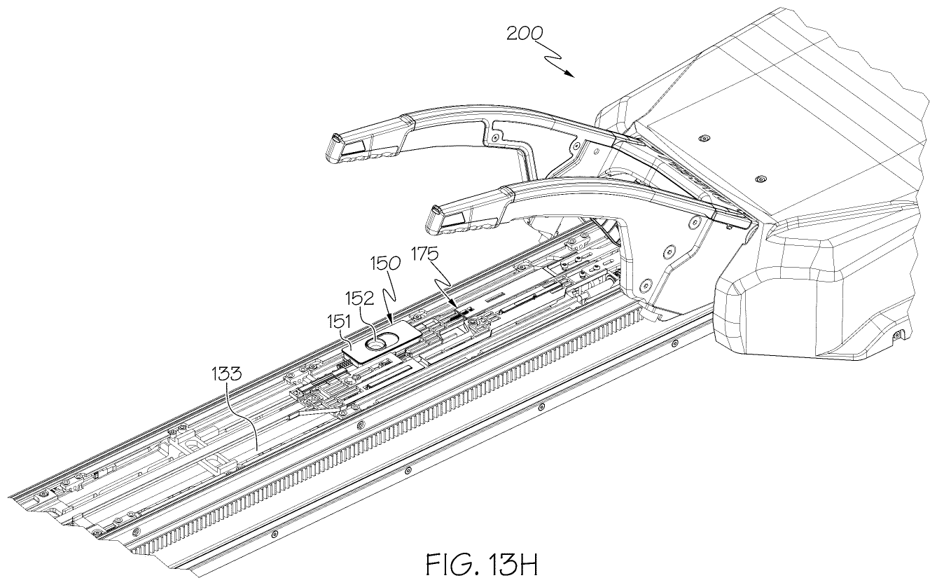

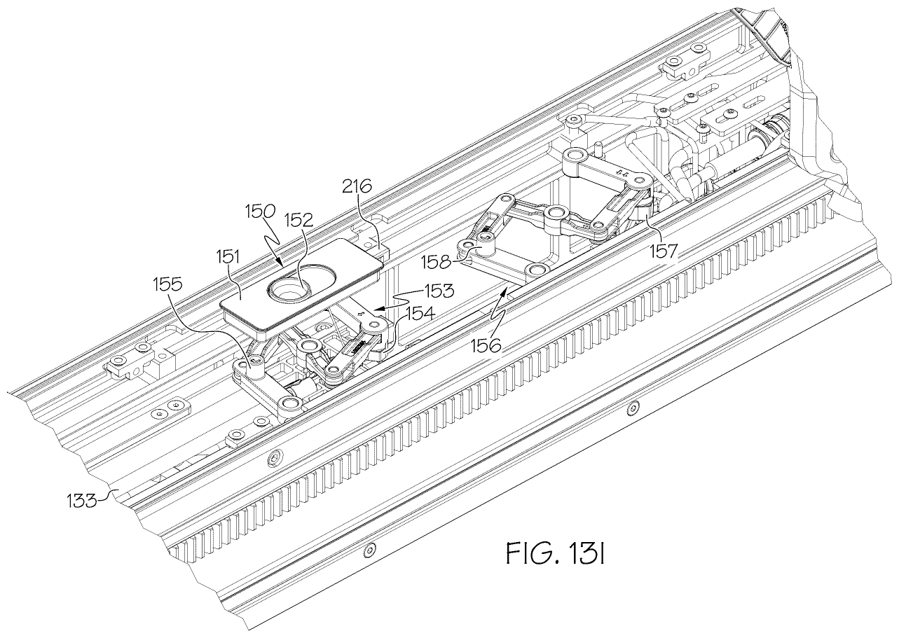

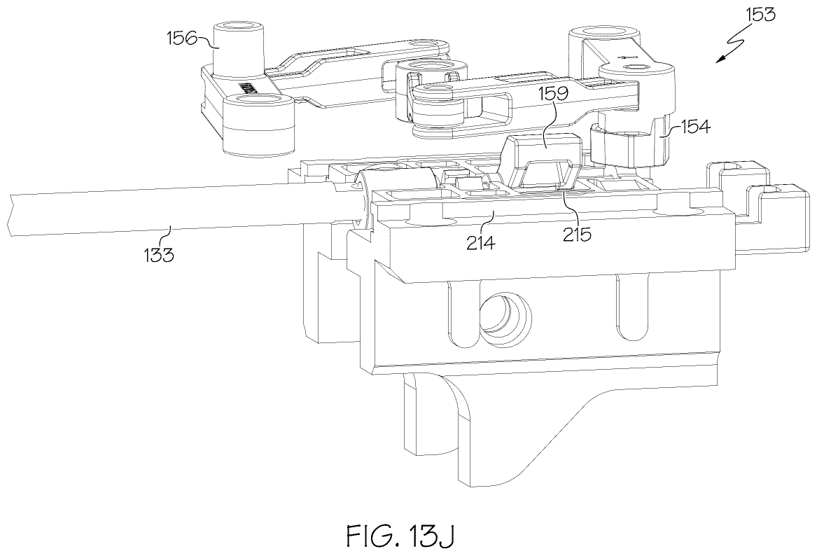

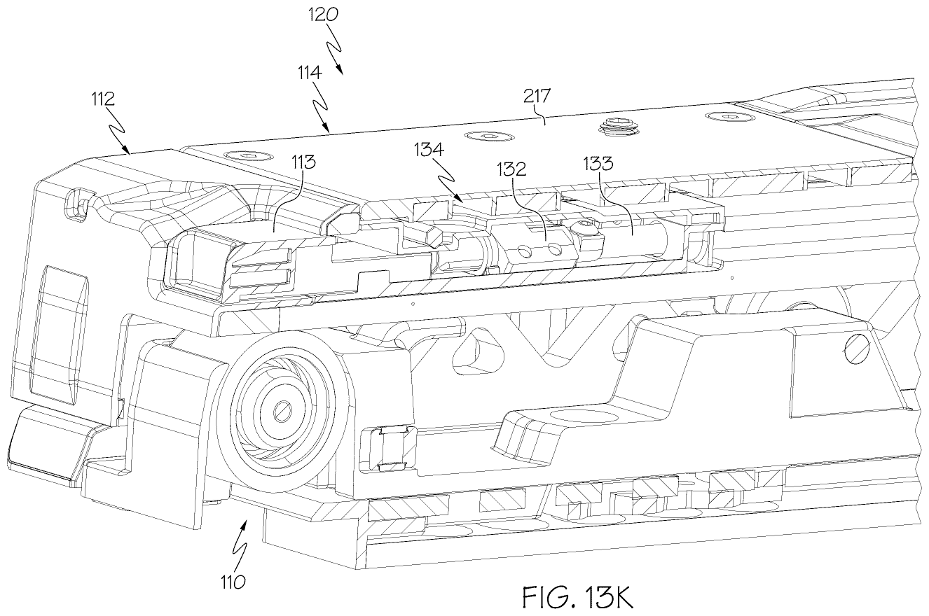

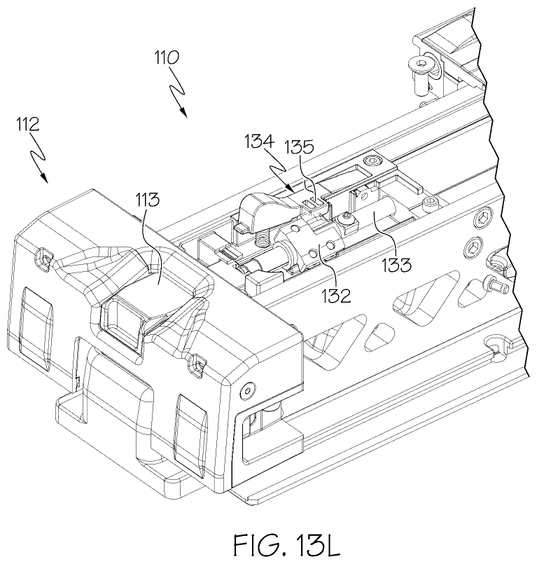

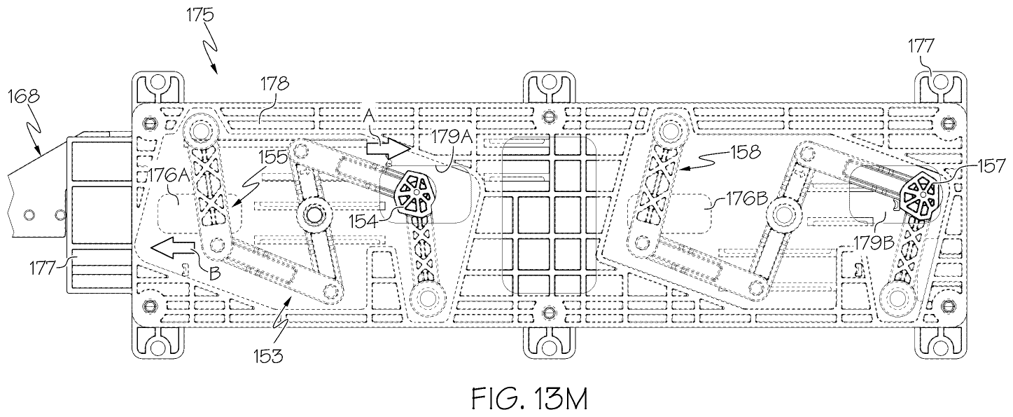

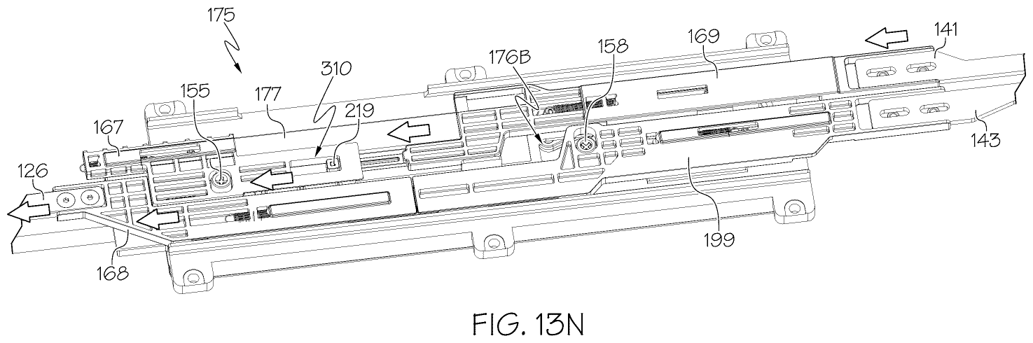

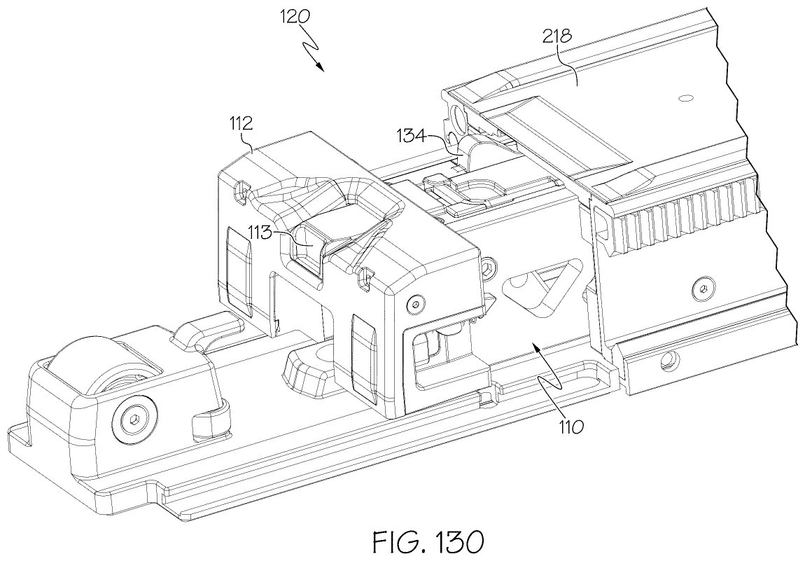

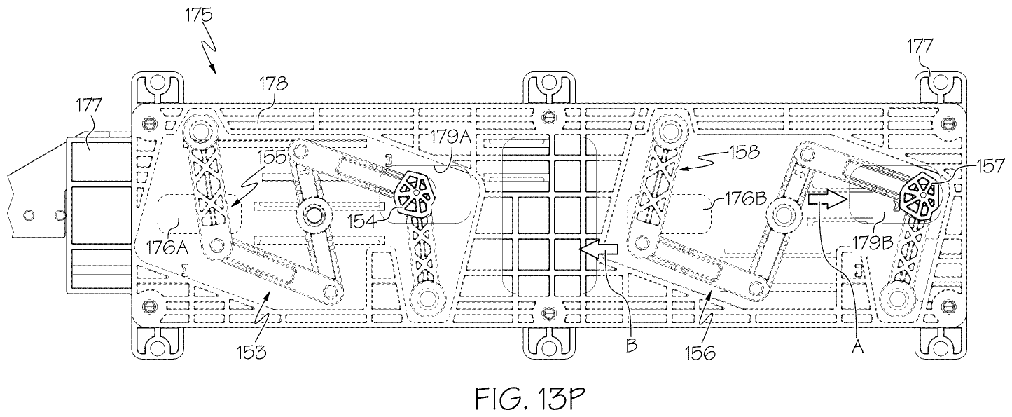

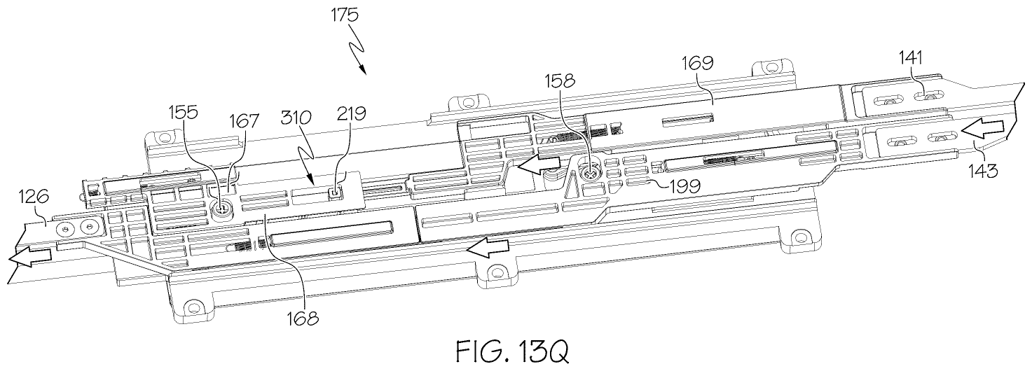

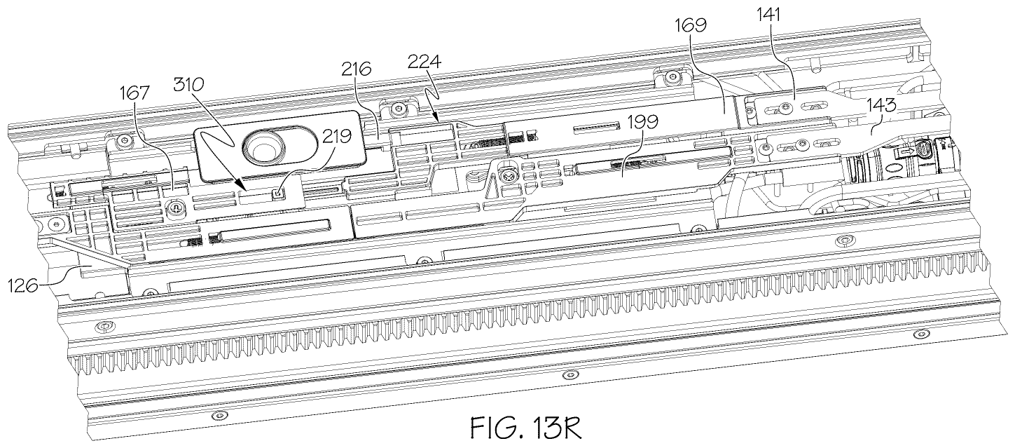

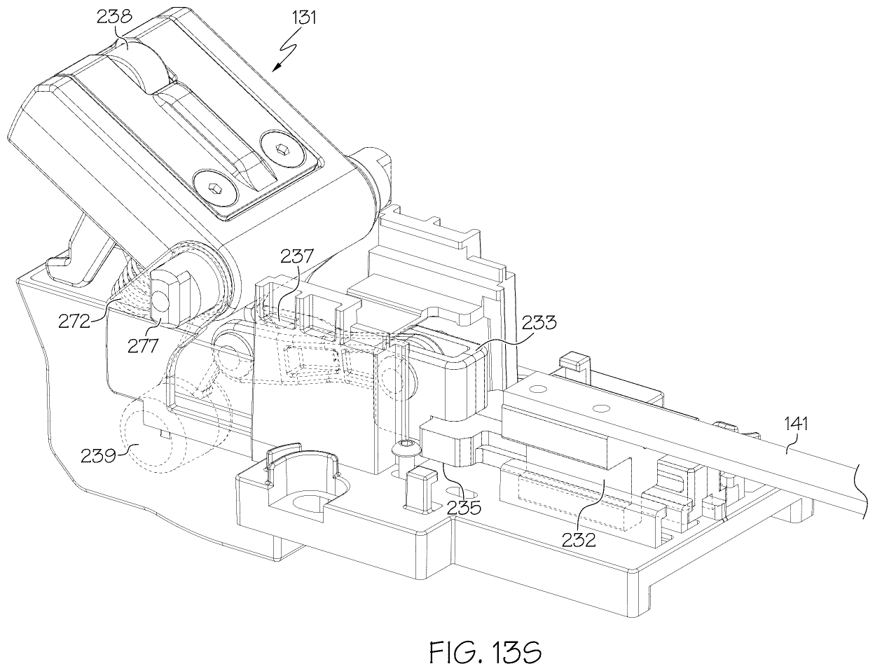

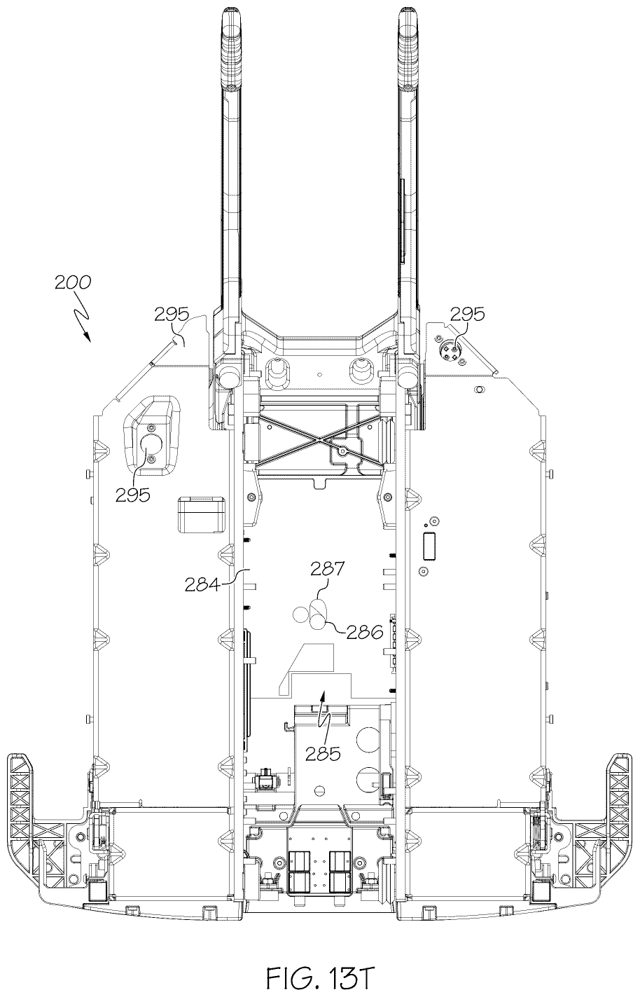

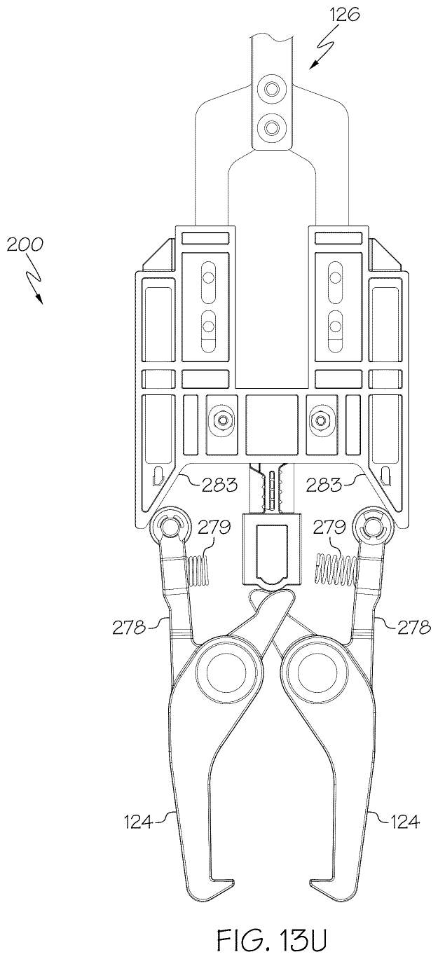

Once the support beam 110 is in the over the top manual use position, the function of the release button 113, located in the end of the support beam 110, changes from releasing the cot fastener (at the fastener receiver 121) and the carriage lock 131 (normal use) to releasing the cot fastener (at the fastener receiver 121) and the latch mechanisms 240 within the carriage 200 that lock the cot to the carriage 200 (Manual Use). Various latch mechanisms and their operations are described in detail below with reference to FIGS. 13A-13R.

To revert from the over the top manual mode back to the normal mode, with no cot loaded and the carriage 200 still locked at the head-end 129 of the fixed rail 120, the user extends the support beam 110 by toggling on the support beam to fixed rail locking mechanisms (i.e., actuation buttons 181 shown in FIG. 7G), extending support beam 110 outwardly away from the head-end 129 of the fixed rail 120.

The removable section 114 is then placed over the support beam 110 and slid into connection with the end roller support section 160 of the fixed rail 120. The tool 212 (e.g., an Allen key) is then used to tighten the removable section 114 to the fixed rail 120 by way of the pins 118. The tightening of the pins 118 lowers the lock portions 211 into the pin holes 139 of the end roller support section 160, and causes the latch arm 208 to be raised within the lock groove 196 such that the hooked end is within the removable section lock notch 204 to fasten the removable section 114 to the fixed rail 120.

Once tightened, the removable section switch (not shown) is enabled, thereby allowing the drive motor 230 to be electrically re-enabled. The user then returns the support beam 110 to the retracted position, which is indicated electrically by a support beam retracted switch (e.g., a second detent switch 129B as shown in FIG. 7O described below) in the fixed rail 120. The cot loading and unloading system 10 is then returned to normal, automatic operation that allows the carriage 200 to move along the fixed rail.

FIGS. 7G-7K illustrate components for locking the support beam 110 to the fixed rail 120, and the carriage 200 to the support beam 110. Referring specifically to FIG. 7G, the support beam 110 includes two support beam locking assemblies 180 on each side of the support beam 110 at the end block 112. Each locking assembly 180 includes a channel 189 for receiving a block 290 (FIG. 7I) positioned on an inner surface of the carriage 200. A protruding actuation button 181 is positioned within the channel 189 and operable to receive the block 290 of the carriage 200. The actuation button 181 is coupled to a lock arm 182 having a hooked end that is operable to lock the support beam 110 to the fixed rail 120 when the support beam 110 is in the fully retracted position and nested within the fixed rail 120.

Referring now to FIG. 7H, left and right inner surfaces of the fixed rail 120 have a side block 195 positioned at the distal end proximate the support beam 110. Each side block 195 includes a lock groove 196 having a lock recess 197 operable to receive the hooked end of the lock arm 182 of the support beam 110. The lock groove 196 has an upper removable section lock notch 204 to lock the removable section as described above and a lower lock recess 197 to lock the support beam 110. It is noted that the first removable side plate 139A and the second removable side plate 139B also include a lock groove 196 for receiving the lock arms 182 of the support beam 110. Thus, the lock arm 182 locks the support beam 110 to the fixed rail 120 removable section 114 when the hooked end of the lock arm 182 is disposed within the lock recess 197. A switch 198 may be provided within the lock 196 to provide feedback to the master control device 190 as to whether or not removable section 114 is locked to the fixed rail.

As stated above, the locking assemblies 180 also lock the support beam 110 to the carriage 200 when the support beam end block 184 loses contact with the fixed rail 120. Referring to FIG. 7I, a locking block 290 is provided on each side of an inner surface of the carriage 200. Each locking block 290 includes a front actuation face 292 and pin receiving groove 291.

Referring once again to FIG. 7G, each locking assembly 180 also includes a carriage lock pin 183 and a pin actuation button 184. The carriage lock pin 183 is operable to be disposed within the pin receiving groove 291 of the locking block 290 to lock the carriage 200 to the support beam 110. FIG. 7J illustrates internal components of the locking assembly 180 with some components of the support beam 110 removed. A first spring 186 biases the actuation button 181 in a direction toward a head-end of the fixed rail 120, which causes the hooked end of the lock arm 182 to rotate down to secure it within the lock recess 197 of the fixed rail 120 or the removable section 114 depending on the mode of operation. A second spring 187 between the carriage lock pin 183 and a cap 194 or other fixed surface biases the carriage lock pin 183 downward to maintain it within the pin receiving groove 291 of the locking block 290.

When the support beam 110 is fully nested within the fixed rail 120 or the removable section 114, the hooked end of the lock arm 182 is within the lock recess 197 of the fixed rail, and an end block of the fixed rail 120 pushes the pin actuation button 184 in a direction away from the fixed rail 120. Referring to both FIGS. 7J and 7K, the pin actuation button 184, which may be disposed through a pin housing 191, has a ramp surface 185 that is moved under a activation portion 193 (i.e., horizontal portion) of the L-shaped carriage lock pin 183 The ramp surface 185 which lifts the locking portion 192 (i.e., vertical portion) up into an extended state to allow the locking block 290 of the carriage 200 to enter the channel 189.

When the carriage 200 reaches the end of the fixed rail 120, the locking blocks 290 enter the channel 189 of the locking assemblies 180. The front actuation face of the locking blocks 290 contact the actuation buttons 181, pushing them forward (i.e., away from the fixed rail 120), which causes the hooked end of the lock arm 182 to lift out of the lock recess 197 of the fixed rail 120. This allows the carriage 200 to push the support beam 110 out of the fixed rail 120. Because the front face of the fixed rail 120 no longer contacts the pin actuation buttons 184, they move back to their biased state, which removes the ramp surface 185 from the horizontal portion of the carriage locking pin 183, thereby allowing the vertical portion of the locking pin 183 to drop into the pin receiving groove 291 of the locking blocks 290 in an extended state. The locking pins 183 being disposed in the pin receiving grooves 291 of the locking blocks 290 locks the support beam 110 to the carriage 200 so that the support beam 110 continues to extend out of the fixed rail 120 until it reaches the end of its travel.

Additional features of the support beam 110 will now be described. Referring to FIG. 7L, the support beam 110 and isolated components of the fixed rail 120 are illustrated to show and describe how the support beam 110 translates within the passageway of the fixed rail 120. The support beam 110 translates on a plurality of rollers of the fixed rail 120. Referring to both FIGS. 7L and 7M, the end roller support section 160 of the fixed rail 120 includes a foot-end roller 166, one or more foot-end vertical rollers 164, and one or more foot-end lateral rollers 165. The foot-end roller 166 is rotationally mounted within an end roller support post 163 that extends from an end roller support base plate 162 of the end roller support section 160. The foot-end roller 166 supports the top plate 116 such that the foot-end roller 166 rotates as the bottom surface of the top plate 116 moves over it as the support beam 110 translates within the passageway of the fixed rail. As shown in FIG. 7M, two foot-end lateral rollers 165 are provided at the end roller support post 163 that contact the inner surfaces of the first support beam member side 115A and the second support beam member side 115B to limit lateral movement of the support beam 110 as it translates in and out of the passageway of the fixed rail 120.

The foot-end vertical rollers 164 are positioned closer to a head-end of the end roller support section 160 than the foot-end roller 166 and are provided to support the support beam 110 when the removable section 114 is removed from the fixed rail 120 and the cot loading and unloading system 10 is operating in manual mode. When in manual mode, the support beam is pushed fully into the passageway of the fixed rail 120, leaving the end roller support post 163 and foot-end roller 166 exposed. Thus, the foot-end vertical rollers 164 support the support beam 110 in this operating mode.

Referring to FIGS. 7L and 7N, the fixed rail 120 also includes a head-end roller assembly 170 that supports a head-end of the support beam 110 with the passageway of the fixed rail 120. The head-end roller assembly 170 includes a head-end roller assembly body 171 having support member recesses 172, head-end vertical rollers 173, and head-end lateral rollers 174. The head-end roller assembly body 171 is mounted to the inner surfaces of the sides of the fixed rail 120 such that it is positioned above the support beam 110 within the passageway of the fixed rail 120. The head-end vertical rollers 173 are rotatably mounted to the head-end roller assembly body 171 such that they contact an upper surface of the top plate 116 of the support beam 110. The head-end vertical rollers 173 rotate as the support beam 110 travels within the passageway of the fixed rail 120. The head-end lateral rollers 174 contact the inner surfaces of the first support beam member side 115A and the second support beam member side 115B to limit lateral movement of the support beam 110 as it translates within the passageway of the fixed rail 120.

The support beam 110 and the fixed rail 120 include components to monitor the position of the support beam 110 relative to the fixed rail 120. These components assist in the controller of the cot loading and unloading system knowing if the support beam 110 is fully extended out of the fixed rail 120, fully retracted in the normal mode with the removable section 114 present, or fully retracted in the manual mode when the removable section 114 is removed from the fixed rail 120.

Referring to FIG. 7O, the fixed rail includes a first ramp block 127A and a second ramp block 127B that interact with a detent engagement assembly 144 of the support beam 110. The first ramp block 127A and the second ramp block 127B are mounted on one or more fixed rail base plates 125 of the fixed rail 120. The first ramp block 127A is closer to the foot-end of the fixed rail 120 than the second ramp block 127B. The first ramp block 127A defines a first detent 128A with a first detent switch 129A. The first ramp block 127A is mounted to the fixed rail base plate 125 at a location associated with a fully extended support beam 110. The first ramp block 127 also includes rollers 315 that support the lower surface of the support beam 110.

The second ramp block 127B defines two detents, a second detent 128B having a second detent switch 129B and a third detent 128C having a third detent switch 129C. It should be understood that in some embodiments the second detent 128B and the third detent 128C each have their own ramp block. The second ramp block 127B is mounted to the fixed rail base plate 125 such that the second detent 128B is at a location associated with a fully retracted support beam 110 in the normal mode with the removable section 114 present, and such that the third detent 128C is at a location associated with a fully retracted support beam 110 in the manual mode with the removable section 114 removed.

Referring to both FIGS. 70 and 7P, the detent engagement assembly 144 includes a swing bar housing 145 that is connected to the head-end of the support beam 110 by fasteners or any other suitable means. The detent engagement assembly 144 further includes a swing bar lever 146 that is pivotably mounted to the swing bar housing 145, and biased toward the base plate 125 by one or more bias members 147 (e.g., springs). A swing bar roller 148 is rotatably coupled to the distal end of the swing bar lever 146. The swing bar housing 145 further comprises two stop arms that are operable to contact stops 316 at the first ramp block 127A to prevent the support beam from extending too far.

As the support beam 110 travels within the passageway of the fixed rail 120, the swing bar roller 148 contacts the base plate(s) 125, the first ramp block 127A and the second ramp block 127B. When the swing bar roller 148 is within a detent, it contacts and activates the corresponding detent switch, which provides a signal to the controller to indicate the position of the support beam 110 within the passageway of the fixed rail 120. The ramps and the detents establish the position of the support beam 110 within the fixed rail 120, as additional force is required to move the swing bar roller 148 out of a detent. FIG. 7P illustrates the swing bar roller 148 in the second detent 128B of the second ramp block 127B, and therefore the support beam 110 being in the fully retracted position in the normal mode with the removable section 114 present.

Referring now to FIG. 8, the fixed rail 120 further includes the fastener receiver 121 that is operable to receive a fastener that extends downwardly toward the fixed rail 120 from an emergency cot, such as the fastener described by U.S. Pat. Appl. No. 63/460,690 which is hereby incorporated by reference in its entirety.

The fastener receiver 121 includes a ramp portion 123 and a slot 122 at the end of the ramp portion 123. The ramp portion 123 raises the height of the slot 122 as compared to the foot-end of the fixed rail 120 to activate latches of the fastener (not shown) to lock the fastener to the receiver. The slot 122 guides the fastener into the fastener receiver 121. It is noted that the fastener of the cot can be slid into the fastener receiver horizontally, and also lowered into the fastener receiver 121 vertically.

The fastener receiver 121 further includes latch mechanisms 124 the prevent the cot fastener on the cot from moving backwards in the fastener receiver 121 when in the locked state. As described in more detail with respect to FIGS. 13H-13R, the latch mechanisms 124 of the fastener receiver 121 are unlocked by pressing the release button 113 on the support beam (see FIG. 7A). The fastener receiver 121 further includes a biased flap 312 at a floor. The biased flap 312 is biased by a spring (not shown) such that it may be pressed down by the fastener of the cot during loading before the fastener is activated to contact the underside surfaces of the fastener receiver 121. The biased flap 312 prevents the fastener of the cot from activating too early, which may prevent the fastener of the cot to be locked into the fastener receiver.

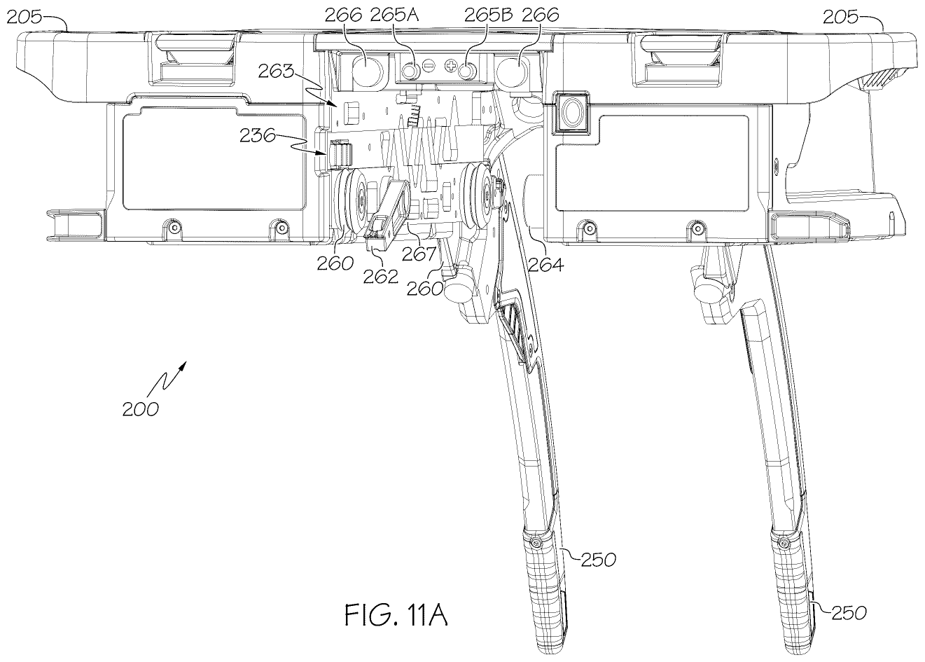

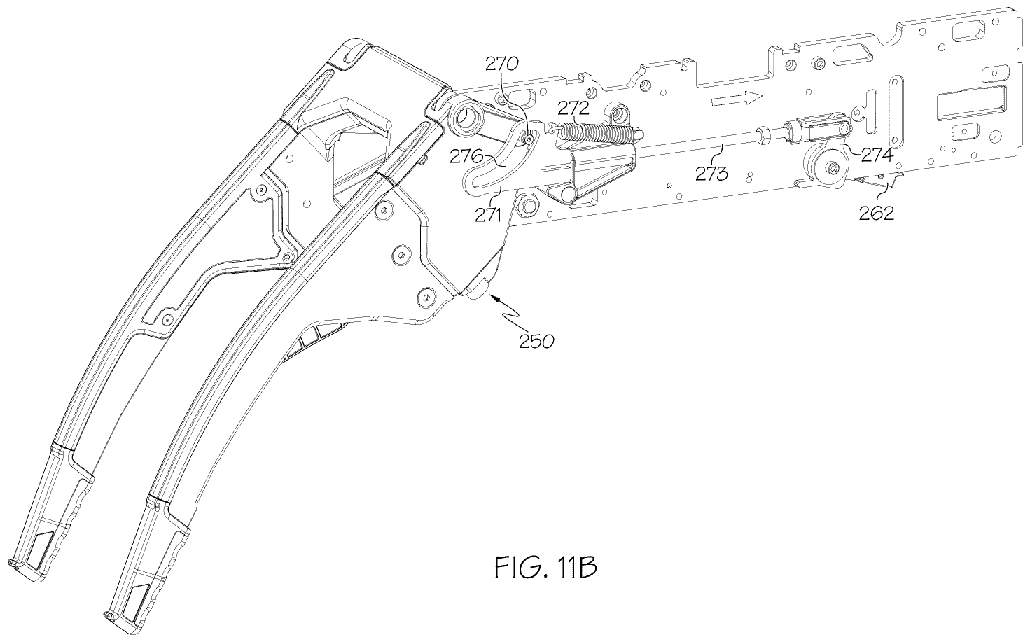

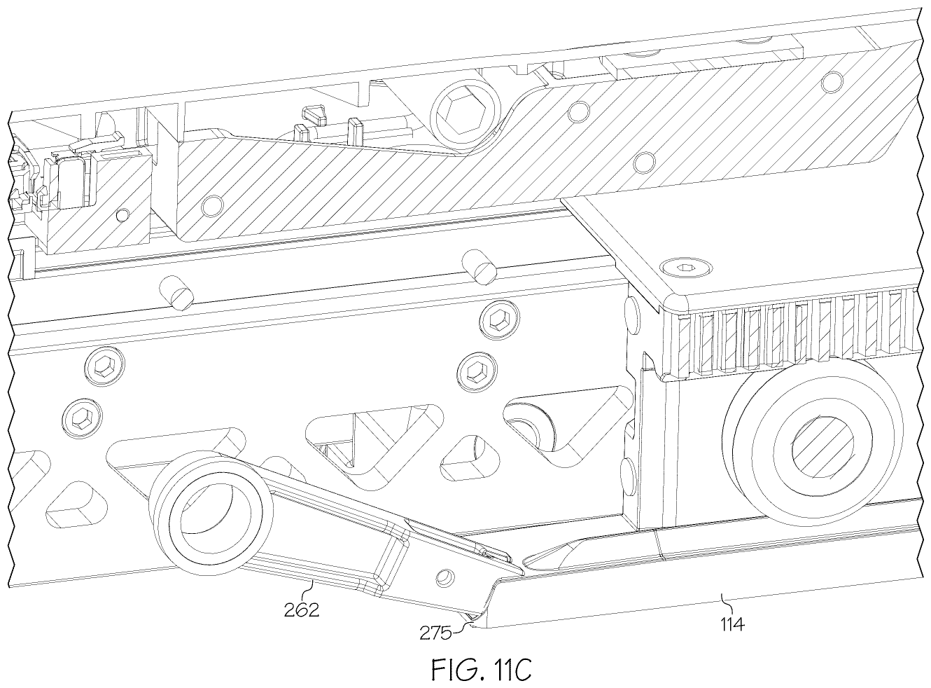

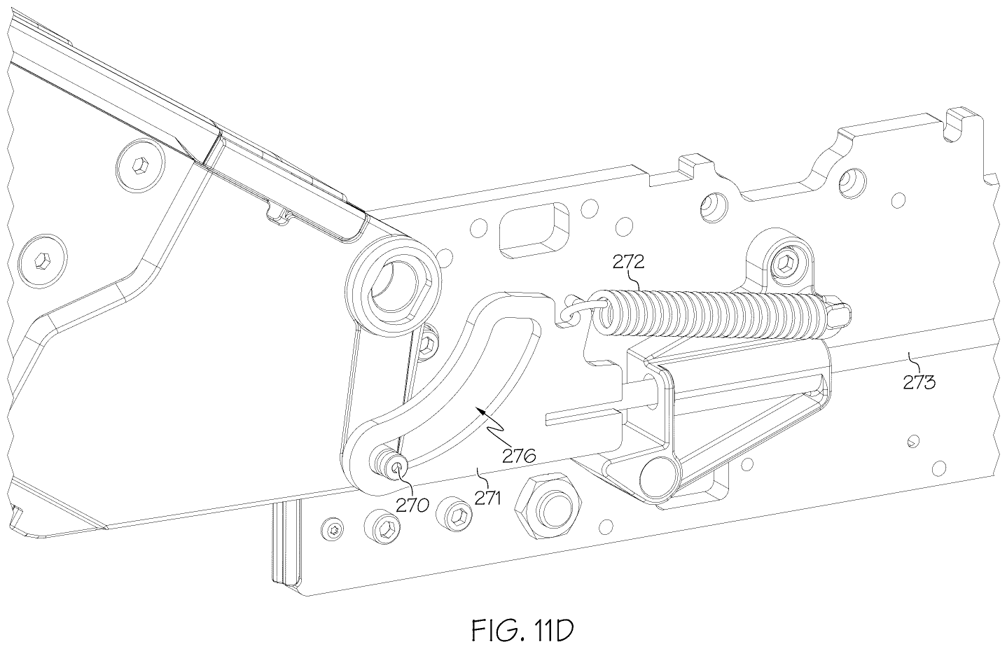

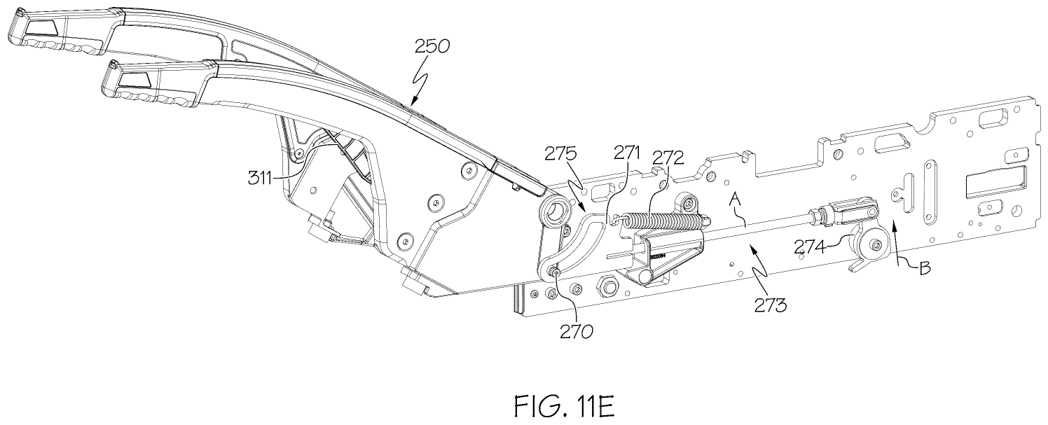

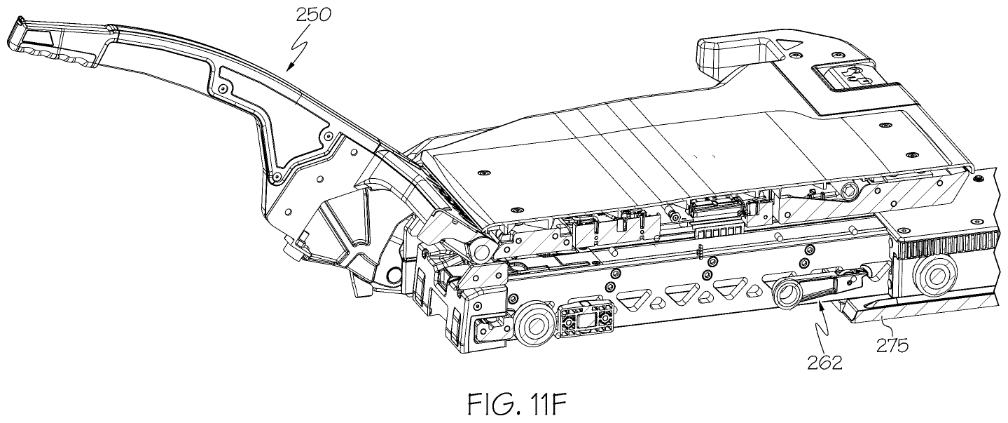

Referring again to FIG. 7A, the fixed rail 120 further includes a carriage stop 142 at the head-end 129. The carriage stop 142 is a flange that provides a stop for the carriage 200 when it is positioned at the head-end 129. The carriage stop 142 further includes electrical contacts 140A 140B that are operable to make electrical contact with corresponding electrical contacts 265A, 265B on the rear-side of the carriage 200, as shown in FIG. 11A. These electrical contacts provide the ability to charge an internal battery within the carriage 200 when the carriage 200 is locked at the head-end 129 of the fixed rail 120. In some embodiments, a switch is provided at the head-end of the fixed rail 120 to provide feedback that the carriage 200 is fully home, which will then allow electrical current to flow from the pins to the internal battery.

In embodiments, housed within the fixed rail 120 are two separate chargers. A first charger provides DC power to the electrical contacts 140A, 140B contacts and the redundant cot battery located in the head end of the fixed rail 120, if provided. The other charger supplies DC power to the carriage 200 to charge the carriage battery. These two chargers may be electrically coupled to the power source of the emergency vehicle, for example.

As described in more detail below with respect to FIG. 9, the fixed rail 120 also includes a carriage lock 131 for locking the carriage 200 to the fixed rail 120 when the carriage 200 is at the head-end 129 of the fixed rail 120.

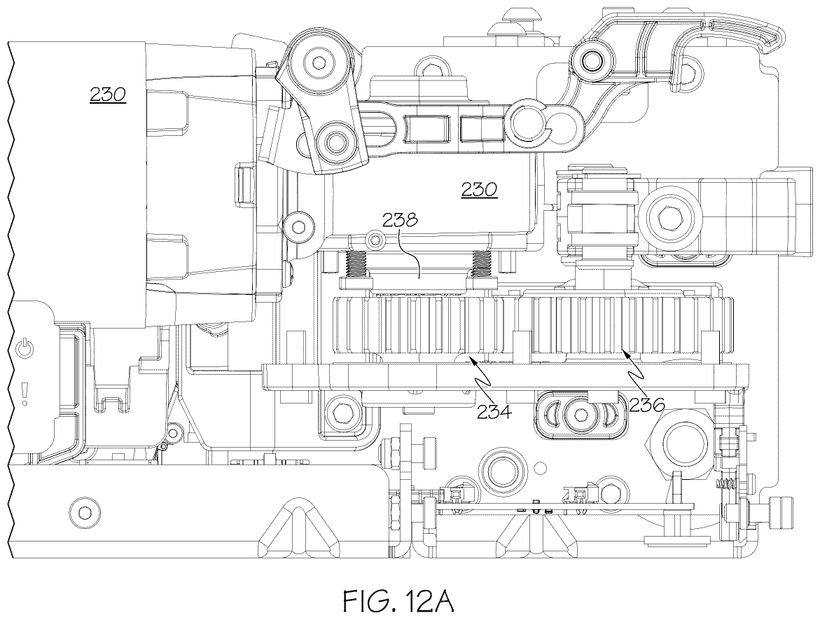

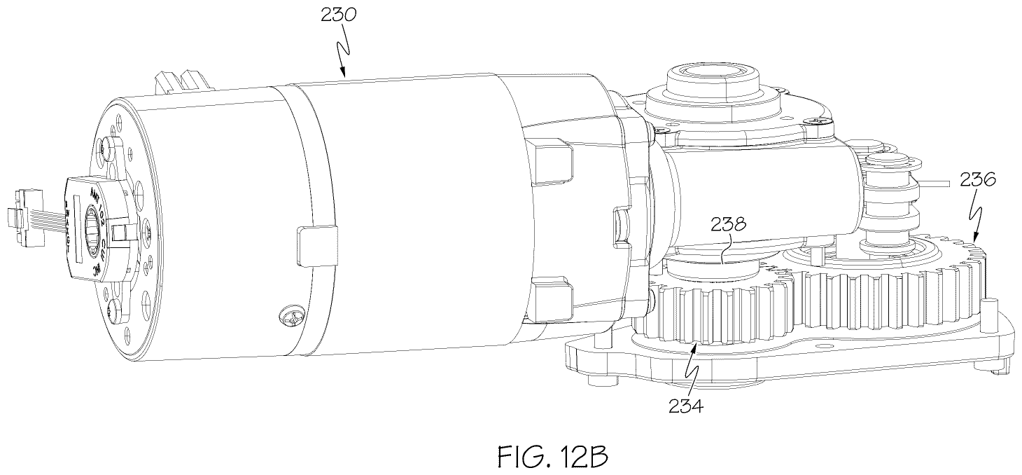

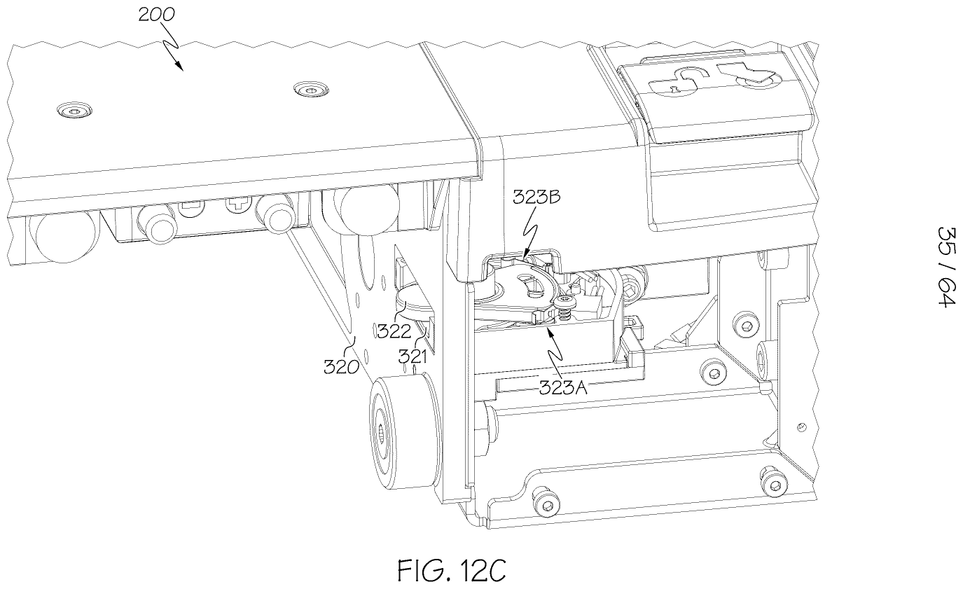

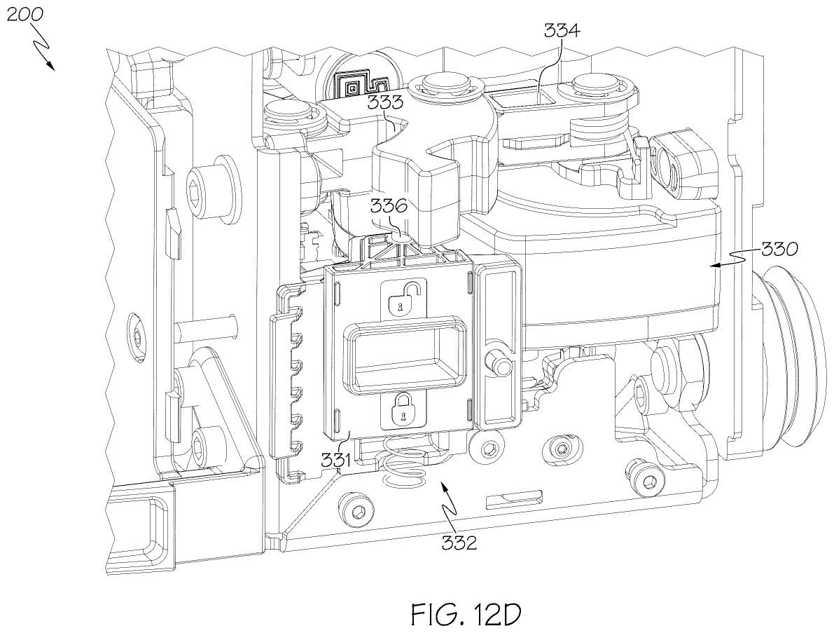

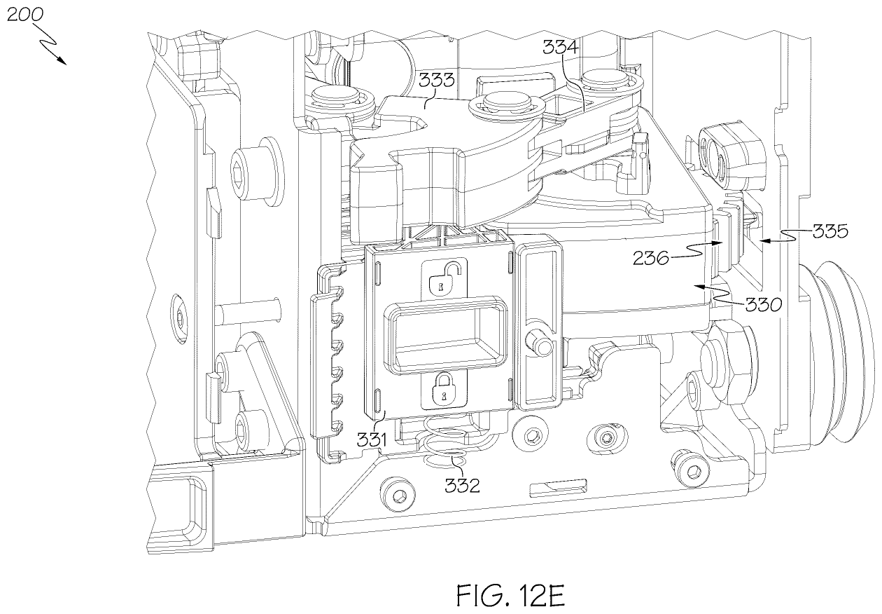

The carriage 200 traverses the fixed rail 120 by use of a rack and pinion drive. In the illustrated embodiment, the linear actuator is a rack and pinion actuator. FIG. 9 illustrates the head-end of the fixed rail with various components removed. The fixed rail 120 includes a track 101A, 101B (see FIG. 7A) on each side. The track 101B on the side of the fixed rail 120 illustrated by FIG. 9 includes a grooved rack member 103 disposed within a groove 102 of the fixed rail 120 operable to receive and guide the drive pinion 236 (see FIGS. 12A and 12B described below). The grooved rack member 103 is mounted to an upper portion of the track 101B by fasteners, for example. In some embodiments the grooved rack member 103 is integral with the track 101B and not a separate component positioned in a groove of the track 101B. The groove rack member 103 further comprises a downward-facing rack protrusion 104 having a V-shape that is operable to guide the wheels of the carriage 200, as described in more detail below.

As shown in FIG. 9, a wheel guide member 105 is attached to a lower portion of the track 101B. For example, the wheel guide member 105 may sit within a groove 107 of the track 101B. The wheel guide member 105 includes an upward-facing wheel guide protrusion 106 operable to guide the wheels of the carriage 200. In some embodiments the wheel guide member 105 is integral with the track 101B and not a separate component within a groove.

Referring to both FIGS. 9 and 10, track 101A of the fixed rail 120 is passive and does not include any drive components. The upper and lower portions of track 101A include grooves 119 that receive cylindrical guide members 108 that are operable to receive and guide wheels of the carriage 200. It should be understood that embodiments are not limited to round grooves 119 and cylindrical guide members 108, and that other shapes may be utilized.

The wheel guide member 105 and the rack protrusion 104 define a wheel recess 213B that receives grooved guide wheels from one side of the carriage 200. The opposing two guide members 108 of track 101A also define a wheel recess 213A that receives guide wheels from the other side of the carriage 200.

Referring now to FIG. 11A, a rear of the carriage 200 is illustrated with various components removed. The carriage 200 is U-shaped such that a passageway 263 extends from the rear end to a front end of the carriage 200. When the carriage 200 is assembled to the fixed rail 120, the fixed rail 120 fits within the passageway 263. A pair of grooved guide wheels 260 is positioned within a side of the passageway 263 that is adjacent to track 101B having the grooved rack member 103. The grooved guide wheels 260 of the illustrated embodiment have a groove operable to mate with a rack protrusion 104 and wheel guide protrusion 106 of track 101B. The rack protrusion 104 and the wheel guide protrusion 106 may take on any profile that prevents lateral movement of the carriage 200 as it travels along the fixed rail 120. In the illustrated embodiment the profile of the rack protrusion and the wheel guide protrusion 106 is V-shaped; however, other shapes may also be utilized. A pair of guide wheels 264 is positioned within a side of the passageway 263 that is adjacent to track 101A.

A drive pinion 236 protrudes through an opening in a wall 267 of the passageway 263. The drive pinion 236 engages the grooved rack member 103 and the rack protrusion 104 and wheel guide protrusion 106 are disposed within the grooves of the grooved guide wheels 260 when the carriage 200 is provided on the fixed rail 120. The grooved guide wheels 260 may have a W-shaped profile or a V-shaped profile; however, other profile shapes are also possible. The protrusions 104, 106 and the grooves of the grooved guide wheels 260 prevent lateral movement of the carriage 200 with respect to the fixed rail 120. The pair of guide wheels 264 contact the cylindrical guide members 108. Each of the grooved guide wheels 260 and the guide wheels 264 may have a cleaning assembly 269 mounted proximate thereto. The cleaning assembly 269 may include a felt pad that cleans the respective guide wheel from dust and debris, and also dispenses a lubricant to reduce friction between the grooved guide wheels 260 and the protrusions 104, 106, and between the cylindrical guide members 108 and the guide wheels 264. In other embodiments, no cleaning assembly is provided.

The carriage 200 further includes carriage lock lever 262 that prevents the carriage 200 from accidentally re-entering the cargo area of the emergency vehicle if the emergency vehicle is nose-down. This carriage lock lever 262 is in the down position only when the arms 250 have lowered enough and the carriage 200 is at the full extended position on the removable section 114 of the fixed rail 120.

Referring now to FIG. 11B, the components that actuate the carriage lock lever 262, which is shown in the deployed (i.e., active) position, are illustrated. In the illustrated example, a pin 270 is provided on an outward side of each arm 250. The pin 270 is positioned within an arcuate slot 276 of a plate 271, which is further coupled to an actuation arm 273. The end of the actuation arm 273 that is opposite from the end coupled to the plate 271 is coupled to a linkage 274, which is further coupled to the carriage lock lever 262. When the arms 250 are down as shown in FIG. 11B, the plate 271 pushes the actuation arm 273 in the direction toward the linkage 274 as shown by the arrow. The plate 271 is biased in the direction of the arrow by spring 272. This causes the carriage lock lever 262 to move down.

FIG. 11C illustrates that when the carriage lock lever 262 is in the down position, it contacts an edge 275 of the removable section 114 (or an end of the end support roller section 160 when the removable section 114 is not present), and prevents the carriage 200 from unintentionally sliding back into the cargo area of the emergency vehicle.

As shown in FIGS. 11D and 11E, when the arms 250 are raised, the pin 270 moves to an end of the arcuate slot 276 of the plate, and then pulls the plate 271 in a direction toward the arms 250, which in turn also pulls the actuation arm 273 in a direction toward the arms 250 as indicated by arrow A in FIG. 11E. The movement of the actuation arm 273 toward the arms 250 causes the linkage to rotate, which in turn causes the carriage lock lever 262 to raise as indicated by arrow B. FIG. 11F illustrates the arms 250 in a raised position such that the carriage lock lever 262 is no longer in contact with the edge 275 of the removable section 114 and the carriage 200 is free to return to the cargo area of the emergency vehicle.

As best shown in FIG. 11E, one of the load arms 250 includes a cot leg engagement switch 311. This cot leg engagement switch 311 is activated when the load arms 250 have raised the cot and the legs of the cot have retracted enough to press and engage the cot leg engagement switch 311. The cot leg engagement switch 311 provides feedback to the master controller 190, that the cot legs are retracted enough to allow the cot entry into the emergency vehicle. Trigger of the cot leg engagement switch 311 may also remove an interlock from power driving the carriage and cot back into the emergency vehicle. The cot leg engagement switch 311 also serves to detect, when unloading a cot, if the arms are lowering and the switch has not been deactivated that the cot legs have not been lowered and lowering will cease.

Referring now to FIGS. 12A and 12B, a side view and a perspective view of the carriage 200 with various components removed to highlight a drive assembly are illustrated, respectively. The carriage 200 includes a drive motor 230 and a motor pinion 234. The drive motor 230 may be any actuator capable of turning the motor pinion 234, such as a stepper motor, a hydraulic motor, or a pneumatic motor, for example. The teeth of the motor pinion 234 are engaged with the teeth of the drive pinion 236 such that when the drive motor 230 rotates the motor pinion 234, the drive pinion 236 also rotates. The teeth of the drive pinion 236 are engaged with the grooves of the grooved rack member 103 such that rotation of the drive pinion 236 translates the carriage 200 along the fixed rail 120.

The drive motor 230 includes an encoder that is utilized to understand the location of the carriage 200 on the fixed rail 120. In addition to the encoder of the drive motor 230, the cot loading and unloading system may also have switches that provide feedback as to the position of the carriage 200 on the fixed rail 120. Referring now to FIG. 12C, an inner wall 320 of the carriage 200 includes an opening 321 through which a switch arm 322 is positioned. The switch arm 322 is pivotally mounted within the carriage 200 to activate a first switch 323A and a second switch 323B based on the direction of travel and position on the fixed rail 120. Referring once again to FIG. 7D, one side of the fixed rail 120 includes a switch track 313 that is operable to receive an end of the switch arm 322 that is through the opening 321 of the inner wall 320. At various locations along the switch track 313 are engagement protrusions 314 that are operable to engage the switch arm 322 to activate the first switch 323A or the second switch 323B depending on the direction of travel. FIG. 7D illustrates the engagement protrusion 314 being proximate the foot-end of the fixed rail 120. Another engagement protrusion 314 may also be provided proximate the head-end of the fixed rail 120, for example. Activation of the first switch or the second switch 323B provides feedback to the controller to understand the location of the carriage 200 on the fixed rail 120 so that the power drive can be operated accordingly. In some embodiments, the engagement protrusions 314 provide a reset for the encoder of the drive motor 230.

The carriage 200 may be configured to have the power drive disengaged so that it operates in a manual mode as desired. In manual mode the drive pinion 236 is pulled away from the rack member 137 so that the carriage 200 can freely be pushed and pulled along the fixed rail 120. Referring now to FIG. 12D, the rear of the carriage 200 includes a power drive release button 331, a power drive release lever 333, a release linkage 334, and a pinion housing 330. The power drive release button 331 is biased in an unlocked position by a bias spring 332. A locking pin 336 extends from the power drive release button 331 into the power drive release lever 333 to prevent the power drive release lever 333 from disabling the power drive motor 230 when the power drive release button 331 is in the unlocked position.

The release linkage 334 is pivotally coupled to the power drive release lever 333 and the pinion housing 330. The drive pinion 236 and the motor pinion 234 are maintained within the pinion housing 330 such that the drive pinion engages the rack member 137 when the power drive release lever 333 is in the locked (i.e., enabled) state as shown in FIG. 12D. A tensioning screw 337 may also be provided to adjust for tolerance issues to ensure that the teeth of the drive pinion 236 engage the teeth of the rack member 137.

FIG. 12E illustrates the carriage 200 in the power drive disengaged state whereby the power drive release button 331 is pushed down into the locked state and the power drive release lever 333 is pushed in a direction away from the pinion housing 330. The movement of the power drive release lever 333 pulls the pinion housing 330 such that the drive pinion 334 is removed from an opening 335 of an inner wall 338 of the carriage 200, and no longer engages the rack member 137. In this state the carriage 200 can be manually pushed and pulled along the fixed rail 120 without the use of the power drive motor 230.

Referring now to FIG. 13A, a side view of the carriage 200 with various components is illustrated. The carriage 200 includes latch mechanisms 240 that latch to pins provided on the emergency cot to lock the emergency cot to the carriage. A latch mechanism 240 is provided on each side of the carriage 200. The example latch mechanism 240 includes a receiving slot 242 for receiving a pin of the emergency cot, and a latch pawl 244 that is operable to be rotated to lock the pin of emergency cot. When the pin is pushed into the receiving slot 242, the latch pawl 244 is rotated about the pin, and the latch mechanism 240 automatically locks the latch pawl 244 to prevent its movement, thereby locking the emergency cot to the carriage 200. A non-limiting example latch mechanism is sold by Eberhard® of Strongsville, OH.

In embodiments, there are multiple means to unlatch an emergency cot from the carriage 200. FIGS. 13B and 13C are perspective views of the carriage 200 with the cover removed to illustrate various components of the latch mechanism 240, as well as components for unlatching the emergency cot from the carriage 200. For each latch mechanism 240, a release linkage 249B interacts with the latch pawl 244 such that movement of the release linkage 249B in direction A causes the latch pawl 244 to rotate in a counter-clockwise direction, which unlatches the emergency cot from the carriage 200. The release linkage 249B further contacts the latch status switch 245 that provides a signal to the master control device 190 as to the status of the latch mechanism 240. When the release linkage 249B is pushed in direction A, the latch status switch 245 is inactivated, thereby indicating that the latch mechanism 240 is in an unlatched state.

The release linkage 249B is further coupled to lever linkage 249A whereby a post 293 of the lever linkage 249A is disposed in a slot 294 of the release linkage 249B. The lever linkage 249A is further coupled to a release lever 248 such that pulling up on the release lever 248 causes the lever linkage 249A and the release linkage 249B to travel in the direction indicated by arrow A. The lever linkage 249A is also coupled to a bar 241 that is operable to rotate when the lever linkage 249A is moved in direction A. The bar 241 is coupled to the lever linkage 249A of both latch mechanisms 240. Thus, pulling up on one release lever 248 causes both latch mechanisms 240 to open.

It is undesirable to unlock an emergency cot from the carriage 200 when the arms 250 are raised. Thus, the carriage 200 includes mechanisms to prevent the unlocking of the latch mechanisms 240 when then arms 250 are in a raised state. Still referring to FIGS. 13B and 13C, a blocking tab 246 is rigidly coupled to the bar 241 which, when blocked by a blocking piece 247, prevents the bar 241 from rotating and therefore prevents the linkage 249A and the release linkage 249B from moving in direction A to cause the latch mechanisms to 240 to unlatch. The blocking piece 247 includes a notch 243 for receiving the blocking tab 246 to rotate when the arms 250 are in the raised position.

Referring to FIGS. 13C and 13D, the blocking arm 247 is coupled to a blocking linkage 251 by a blocking tab 255 of the blocking arm 247 that is disposed within a blocker slot 256 of the blocking linkage 251. An end of the blocking linkage 251 opposite from the blocking slot 256 is coupled to a follower 254, which is further coupled to blocking load arm linkage 257. The blocking load arm linkage 257 is further coupled to an individual load arm 250. When the load arms 250 raise, the blocking load arm linkage 257 pivots the follower 254, which allows a compression spring (not shown) to push the blocking linkage 251 in direction A (FIG. 13C). The end of the blocker slot 256 contacts the blocking tab 255 when the load arms 250 reach a certain height, which pushes the blocking arm 247 in direction A. When the load arms 250 are lowered, the blocking linkage 251 pulls the blocking arm 247 to overcome the force of the compression spring in the direction of arrow B in FIG. 13D, which allows the blocking tab 246 to rotate downward as shown by arrow C in FIG. 13E.

It may be important to override the blocking arm 247 and the blocking tab 246 to allow the latch mechanisms 240 to become unlatched to remove the emergency cot from the carriage 200, such as in an emergency situation. Referring now to FIG. 13F, an override button 258 is provided at the rear of the carriage 200. The override button 258 is also visible in FIG. 6. The override button 258 is disposed within a cavity of a housing 261. The blocking piece 247 further includes an override arm 259, a portion of which is disposed within the cavity of the housing 261 and contacts the override button 258. When a user pushes the override button 258 into the cavity, the override arm 259 is also pushed forward in direction A, which moves the entire blocking piece in direction A so that it does not interfere with rotation of the blocking tab 246 and bar 241. Thus, when the override button is pressed, the emergency cot may be unlocked from the carriage 200 using the release latches.

Referring once again to FIG. 13D, the actuator 277 for driving the load arms 250 is shown. The actuator 277 is a hydraulic actuator that is configured as a fully self-contained unit without an external reservoir, pump or connecting hoses. This design benefits any servicing and maintenance needed on the hydraulic cylinder of the actuator 277. It should be understood that in other embodiments, the pump and reservoir may be external components.

In embodiments of the present disclosure, it is also possible to unlatch an emergency cot from the carriage 200 using a button on the cot. Referring now to FIG. 13G, the bar 241 is configured as a hollow tube. There is an inner bar 266 disposed within the bar 241. A notch in the hollow bar 241 provides clearance for a pusher bracket 268 to be attached to the inner bar 266. A release arm 281 is coupled to the pusher bracket 268 at a first end and an actuator 280 at a second end. The actuator 280 provides linear actuation of the release arm 281. When the control system logic allows, depressing of a button on the emergency cot extends the actuator 280, which moves the release arm 281 in direction E and pushes the pusher bracket 268 so that the inner bar 266 rotates. Rotation of the inner bar 266 causes movement of the linkage 249A and the release linkage 249B to unlatch the latch mechanisms 240. The position of the blocking piece 247 is irrelevant with respect to this release method because it relies on electrical switch signals to allow the use of the electrical actuator 280, and further because the blocking tab 246 extends from the outer bar 241, which does not rotate using this method.

There is another method of unlatching an emergency cot from the carriage 200 when the cot loading and unloading system 10 is operated in a manual mode and the removable section 114 is removed. Because in manual mode the carriage 200 is locked at the head end of the fixed rail, to avoid the user from needing to enter into the vehicle to release the release levers 248, the release button 113 (see FIG. 1) on the support beam member 111 also unlatches the latch mechanisms 240 to unlatch the emergency cot from the carriage. As described in more detail below, when the release button 113 is pressed, a slide plate 288 (FIG. 7A) on the fixed rail 120 is translated toward the foot-end of the fixed rail 120. Still referring to FIG. 13G, the slide plate 288 is coupled to a carriage release post 286, which is also coupled to a first end of a carriage release flipper 289. The second end of the carriage release flipper 289 contacts or is otherwise coupled to the release arm 281. When the release button 113 on the support beam is pressed, the slide plate 288 is moved toward the foot-end of the fixed rail 120, which pulls the carriage release post 286 toward the foot-end of the fixed rail 120 and rotates the carriage release flipper 289 such that is pushes the release arm 281 as indicated by arrow E to rotate the inner bar 266 and open the latching mechanisms 240. As described in more detail below, the release button 113 performs unlocking functions when the cot loading and unloading system 10 is in normal mode or manual mode.

Referring now to FIG. 13H, the cot loading and unloading system 10 includes a switch plate assembly 175 within the fixed rail 120 that is operable to control the carriage lock 131 (FIG. 9), the latch mechanisms 124 of the fastener receiver 121 (FIG. 8), and/or the latch mechanism 240 that latch the carriage to the cot (FIGS. 13A-13C) depending on whether the cot loading and unloading system 10 is operating in the normal mode or the manual mode.

Referring to FIG. 13I, the switch plate assembly 175 includes a first linkage assembly 153 and a second linkage assembly 156, each of which comprise five pivotably coupled links. As described in more detail below, the first and second linkage assemblies 153, 156 actuate sliders of the switch plate assembly 175 that push and pull on link arms to control the carriage lock 131, the latch mechanisms 124 of the fastener receiver 121, and the latch mechanisms 240 that latch the carriage 200 to the cot.

A head-end link of the first linkage assembly 153 has a first input arm 154 that extends downward toward the base plate 125 of the fixed rail 120, and a first output arm 155 that extends upward in a direction away from the base plate 125 of the fixed rail 120. Similarly, a head-end link of the second linkage assembly 156 has a second input arm 157 that extends downward toward the base plate 125 of the fixed rail 120, and a second output arm 158 that extends upward in a direction away from the base plate 125 of the fixed rail 120. Force that is applied to the first and second input arms 154, 157 cause movement of the first and second output arms 155, 158 of the first and second linkage assemblies 153, 156, respectively.

The first linkage assembly 153 is used to actuate the carriage lock 131 and the latch mechanisms 124 of the fastener receiver 121 in the normal mode (i.e., a first mode). The second linkage assembly 156 is used to actuate the latch mechanisms 240 that latch the carriage 200 to the cot as well as to actuate the latch mechanisms 124 of the fastener receiver 121.

FIG. 13J illustrates a release rod 133 that is coupled to the release button 113 at a first end (see FIG. 1) and a flip-flop tab 159 at a second end. The flip-flop tab 159 is operable to contact and move the primary input arm 154 toward the head-end of the fixed rail 120, which in turn moves the first output arm 156 toward the foot-end of the fixed rail 120 to unlock the carriage lock 131 and the latch mechanisms 124 of the fastener. The flip-flop tab 159 is disposed within a flip-flop plate 214 having a flip-flop recess 215. The flip-flop plate 214 is coupled to the head-end of the support beam 110 and therefore may travel within the fixed rail 120 on the support beam 110.

When the cot loading and unloading system 10 operates in the normal mode (i.e., the removable section 114 is installed on the fixed rail 120), the flip-flop tab 159 is rotated up so that it may contact the first input arm 154 as shown in FIG. 13J. However, when the cot loading and unloading system 10 operates in the manual mode (i.e., the removable section 114 is removed from the fixed rail 120), the flip-flop tab 159 rotates downward so that it is within the flip-flop recess 215 and can pass under the first input arm 154 as the support beam 110 is pushed into the fixed rail 120. When the support beam 110 is fully disposed in the passageway of the fixed rail 120 when the removable section 114 is removed, the flip-flop tab 159 rotates back upward out of the flip-flop recess 215 so that it may contact the second input arm 157. The flip-flop tab 159 is then operable to contact and move the second input arm 157 toward the head-end of the fixed rail 120, which in turn moves the second output arm 158 toward the foot-end of the fixed rail 120 to unlock the latch mechanisms 240 that latch the cot to the carriage 200 as well as to actuate the latch mechanisms 124 of the fastener receiver 121.

Referring now to FIG. 13K, the foot-end of the support beam 110 includes mechanisms to rotate the flip-flop tab 159 when the cot loading and unloading system 10 changes operation between the normal mode and the manual mode. The foot-end of the release rod 133 is coupled to a flipper 132, which contacts an end of the release button 113. When the release button 113 is pressed, it pushes the flipper 132 and the release rod 133 toward the head-end of the fixed rail 120.

The flipper 132 is operable to rotate the release rod 133, which in turn rotates the flip-flop tab 159. FIG. 13K illustrates the cot loading and unloading system 10 in the normal mode with the removable section 114 present. The presence of the removable section 114 causes the flipper 132 to be rotated in a manner such that the flip-flop tab 159 is flipped up out of the flip-flop recess 215. More particularly, a position lever 134 rotates the flipper 132 to flip up the flip-flop tab 159 when the position lever 134 is pushed down by the top plate 217 of the removable section 114.

FIG. 13L illustrates the support beam 110 with the removable section 114 removed. The position lever 134 is biased upward away from the ground by a bias member such as a spring. The position lever 134 includes a rocker tab 135 that is coupled to or otherwise contacts the flipper 132. When the removable section 114 is removed, the rocker tab 135 of the position lever 134 is raised, which allows the flipper 132 to rotate, which in turn rotates the flip-flop tab 159 into the flip-flop recess 215. Positioning the flip-flop tab 159 into the flip-flop recess 215 allows the flip-flop tab 159 to pass beneath the first input arm 154 when the user pushes the support beam 110 toward the head-end of the cot loading and unloading system 10 so that it is fully disposed within the passageway of the fixed rail 120.

When the support beam 110 is within the passageway of the fixed rail 120, the position lever 134 is deflected down by a top plate 218 of the fixed rail 120 (FIG. 13O) in the same manner as when the removable section 114 is present. This causes the rocker tab 135 to press down on the flipper 132 and in turn rotates the flipper 132 and the release rod, which further causes the flip-flop tab 159 to rotate out of the flip-flop recess 215. With the support beam 110 fully positioned within the passageway of the fixed rail 120 and the flip-flop tab 159 positioned out of the flip-flop recess 215, the flip-flop tab 159 is now ready to contact the second input arm 157 when the user presses the release button 113 on the support beam 110.

The first input arm 154 and the second input arm 157 control the switch plate assembly 175 to actuate the carriage lock 131, the latch mechanisms 124 of the fastener receiver 121, and the latch mechanisms 240 that latch the carriage 200 to the cot.

Referring now to FIG. 13M, a bottom surface of the switch plate assembly 175 (i.e., the surface of the switch plate assembly 175 facing the base plate 125 of the fixed rail 120) is illustrated. The switch plate assembly 175 includes a lower base plate 178 and an upper base plate 177 that are mounted within the passageway of the fixed rail 120. The upper base plate 177 and the lower base plate 178 are coupled together to define an enclosure in which the first linkage assembly 153 and the second linkage assembly 156 are positioned. The lower base plate 178 includes a first input opening 179A and a second input opening 179B through which the first input arm 154 and the second input arm 157 are disposed, respectively. The upper base plate 177 has a first output opening 176A and a second output opening 176B through which the first output arm 155 and the second output arm 158 are disposed, respectively.

FIG. 13M illustrates actuation of the switch plate assembly 175 when the cot loading and unloading system 10 operates in the normal mode. The first input opening 179A has a slot-like shape to allow the first input arm 154 to translate toward the head-end of the fixed rail 120 as indicated by arrow A when it is pressed by the flip-flop tab 159. Movement of the first input arm 154 toward the head-end of the fixed rail 120 causes the first output arm 155 to translate within the first output opening 176A in a direction toward the foot-end of the fixed rail 120 as indicated by arrow B.

Referring now to FIG. 13N, a top view of the switch plate assembly 175 when operating in the normal mode is illustrated. The switch plate assembly 175 further includes a fastener slider 168, an intermediate slider 167, a carriage slider 169 and a latch slider 199, which of which are slideably disposed within the upper base plate 177 so that they may longitudinally travel back and forth between the head-end and foot-end directions of the fixed rail 120.

The first input arm 155 is coupled to the intermediate slider 167, and is further coupled to the carriage slider 169. In the illustrated embodiment, the intermediate slider 167 is coupled to the carriage slider by a slot 310 within the intermediate slider 167 that receives an end of a hooked arm 219 of the carriage slider 169. This arrangement is such that the carriage slider 169 can move toward the foot-end of the fixed rail 120 independently of the intermediate slider 167.

The intermediate slider 167 is shaped such that it contacts a portion of the fastener slider 168 so that it may push the fastener slider 168 in a direction toward the foot-end of the fixed rail 120. The fastener slider 168 is coupled to a fastener link arm 126 that is operable to actuate the latch mechanisms 124 of the fastener receiver 121 to unlock the cot fastener from the fastener receiver 121. The carriage slider 169 is further coupled to a carriage link arm 141 that is operable to actuate the carriage lock 131 to unlock the carriage 200 from the fixed rail 120. The latch slider 199 is coupled to the second output arm 158 and a latch link arm 143. The latch link arm 143 is operable to actuate the latch mechanisms 240 that unlatch the carriage 200 from the cot. The latch slider 199 also contacts the fastener slider 168 to push the fastener slider 168 toward the foot-end of the fixed rail 120.

When removable section 114 is installed on the fixed rail 120, the support beam 110 is in a fully retracted position within the removable section 114 and the fixed rail 120, and the user presses the release button 113 on the support beam 110, the first input arm 154 moves toward the head-end of the fixed rail 120 (FIG. 13M) and the first output arm 155 moves toward the foot-end of the fixed rail 120 (FIG. 13N). Movement of the first output arm 155 causes the intermediate slider 167 to move toward the foot-end of the fixed rail 120 so that it pushes the fastener slider 168 and pulls the carriage slider 169 toward the foot-end of the fixed rail 120 by way of the slot 176 and the hooked arm 219. This movement of the fastener slider 168 also moves the fastener link arm 126 toward the foot-end of the fixed rail 120 to actuate the latch mechanisms 124 of the fastener receiver 121 to unlock the cot fastener from the fastener receiver 121. This movement of the carriage slider 169 also moves the carriage link arm 141 to actuate the carriage lock 131 to unlock the carriage 200 from the fixed rail 120. Thus, in the normal mode the release button both unlocks the cot from the fixed rail at the fastener receiver 121 and also unlocks the carriage 200 from the fixed rail 120 so that the carriage 200 can bring the cot to the foot-end of the fixed rail 120.

Referring now to FIG. 13O and as described above, when the removable section 114 is removed and the support beam 110 is pushed into the passageway of the fixed rail 120, the position lever 134 is pushed downward due to contact with the top plate 218. The movement of the position lever 134 rotates the flip-flop tab 159 up and out of the flip-flop recess 215 so that it is ready to contact the second input arm 157 when the release button 113 is pressed in the manual mode.

Referring now to FIG. 13P, a bottom view of the switch plate assembly 175 when operated in the manual mode is illustrated. When the flip-flop tab 159 pushes the second input arm 157 toward the head-end of the fixed rail 120 within the second input opening 179B as indicated by arrow A, the second linkage assembly 156 causes the second output arm 158 to translate in the second output opening 176B in a direction toward the foot-end of the fixed rail 120 as indicated by arrow B.

Referring now to FIG. 13Q, a top view of the switch plate assembly 175 when operated in the manual mode is illustrated. When removable section 114 is removed from the fixed rail 120, the support beam 110 is in a fully retracted position within the passageway of the fixed rail 120, and the user presses the release button 113 on the support beam 110, the second input arm 157 moves toward the head-end of the fixed rail 120 (FIG. 13P) and the second output arm 158 moves toward the foot-end of the fixed rail 120 (FIG. 13Q). Movement of the second output arm 158 causes the latch slider 199 to move toward the foot-end of the fixed rail 120 so that it pushes the fastener slider 168 and the fastener link arm to unlock the fastener receiver 121. This movement of the fastener slider 168 also moves the fastener link arm 126 toward the foot-end of the fixed rail 120 to actuate the latch mechanisms 124 of the fastener receiver 121 to unlock the cot fastener from the fastener receiver 121. This movement of the latch slider 199 pulls the latch link arm 143 to actuate the latch mechanisms to unlock the cot from the carriage 200. Thus, in the manual mode the release button 113 both unlocks the cot from the fixed rail at the fastener receiver 121 and also unlocks the cot from the carriage 200 so that the cot can be pulled to the foot-end of the fixed rail 120 while the carriage 200 remains at the head-end of the fixed rail 120.

In some embodiments, the cot loading and unloading system 10 includes a carriage release bypass option that allows a user to release the carriage lock 131 to allow the carriage 200 to be moved toward the foot-end of the fixed rail 120 for maintenance or other purposes. Referring briefly once again to FIG. 13H, the fixed rail 120 includes a secondary release 150 that the user can actuate to unlock the carriage lock 131. The secondary release 150 includes a secondary release button 152 within a secondary release plate 151 that is biased by a bias member in the head-end direction. The secondary release button 152 comprises a release arm 216 having a hoked end.

Referring now to FIG. 13R, the hooked end of the release arm 216 is positioned within a slot 224 of the carriage slider 169. When the user pulls the secondary release button 152 toward the foot-end of the fixed rail 120, the release arm 216 pulls on the carriage slider 169, which also pulls on the carriage link arm 141 to unlock the carriage lock 131 as shown by the arrows, thereby allowing the carriage 200 to move toward the foot end of the fixed rail 120 when there is no cot present. The carriage slider 169 can move independently of the intermediate slider 167 when the secondary release button 152 is pulled because the hooked arm 219 travels within the slot of the fastener slider 168 without causing the fastener slider 168 to translate.

Referring now to FIG. 13S, the carriage lock 131 and its associated components are illustrated in isolation. The carriage link arm 141 is coupled to a carriage link block 232 that is further coupled to a carriage slide block 233. A carriage lock linkage 237 is pivotally coupled to the carriage slide block 233 at a first end, and a carriage lock arm 239 of the carriage lock 131 at the other end. The carriage lock 131 is biased upward away from the fixed rail 130. When the carriage 200 rolls over the fixed rail 120 in a direction toward the head-end of the cot loading and unloading system 10, it pushes the carriage lock 131 down with assistance from a carriage lock roller 238. However, when the carriage 200 clears the carriage lock 131 the carriage lock 131 flips back up to prevent the carriage 200 from traveling back toward the foot-end of the cot loading and unloading system 10. The roller 238 may be provided to limit wear and tear on the lock from the underside of the carriage 200.

FIG. 13T illustrates a bottom view of the carriage 200. The carriage 200 includes a bottom plate 284 having a locking notch 285 that receives the carriage lock 131 when the carriage 200 is locked to the fixed rail 120. The placement of the carriage lock 131 within the locking notch 285 prevents the carriage 200 from moving toward the foot-end of the fixed rail 120.

To unlock the carriage 200 from the fixed rail 120, the user presses the release button 113 on the support beam 110, which causes the carriage link arm 141 to be pulled back toward the foot-end of the cot loading and unloading system 10. The carriage link arm 141 thus pulls on the carriage link block 232 which in turn pulls on the carriage slide block 233. The linear motion of the carriage slide block 233 causes the carriage lock linkage 237 to both pull on the carriage lock arm 239 and pivot downward. Pulling on the carriage lock arm 239 moves the carriage lock 131 downward toward the fixed rail 120 into an unlocked position so that the carriage 200 can then move past the carriage lock 131 toward the foot-end of the cot loading and unloading system 10.

The bottom plate 284 further includes a slot 287 through which the carriage release post 286 is disposed and accessible to the slide plate 288 to activate the carriage lock 131.

FIG. 13T also illustrates that the underside of the carriage 200 may include environmental lights 295 at the foot-end. The environmental lights 295 illuminate the ground surface near the emergency vehicle and the cot to assist personnel in loading and unloading the cot from the cot loading and unloading system.

Referring now to FIG. 13U, the fastener receiver 121 and associated components are illustrated in isolation. The fastener receiver 121 comprises a pair of latch mechanisms 124 each having an arm 278 that receives an outward biasing force by a latch bias member 279. The latch bias members 279 bias the pair of latch mechanisms 124 in a latched state such that they are latched around a fastener on the cot when the fastener is inserted into the fastener receiver 121, thereby preventing longitudinal movement of the cot along the fixed rail 120. The fastener link arm 126 is coupled to a fastener slide block 282 that is operable to be pushed toward the foot-end of the cot loading and unloading system 10 when the user presses the release button 113 as described above. The fastener slide block 282 has tapered actuator surfaces 283 that contact an end of the latch arms 278. When the fastener slide block 282 is pushed forward toward the foot-end of the cot loading and unloading system 10, the tapered actuator surfaces 283 pivot the latch arms 278 inwardly toward one another, which causes the latching ends of the latch mechanisms to pivot outwardly away from one another, which transitions the fastener receiver 121 into an unlatched state so that the fastener can be removed from the fastener receiver 121 and the cot unlatched from the fixed rail 120.

The carriage slide block 233 further includes switch protrusions 235 on its sides that contact switches (not shown) when the carriage link arm 141 is pulled back to indicate to the controller that the carriage lock 131 is down in an unlocked position.

Referring once again to FIG. 6, the example carriage 200 includes a spare battery container 220 that is removably positioned within the passageway of the fixed rail 120. The spare battery container 220 is operable to store a spare battery for the emergency cot. Spare batteries are typically located loosely within the cargo area of the emergency vehicle, such as in a container, bag, or on a rack, which causes them to be frequently replaced. The integrated storage functionality of the spare battery container 220 ensures that the spare battery is always located in a known location. Further, as the carriage 200 is crash-rated, the spare battery container 220 provides a crash-rated location for the spare battery, which is typically a lithium battery.

FIG. 14 illustrates a perspective view of an example spare battery container 220 in isolation. The spare battery container 220 generally comprises a floor 223 and a rear wall 226, a first side wall 228, a second side wall 229, and a front wall 227 extending from the floor 223 to form a partial enclosure 221. The spare battery (not shown) rests on the floor 223 within the partial enclosure 221. A wire harness and/or electrical connections (not shown) may be provided to enable charging of the spare battery. The rear wall 226 further includes a window 225 that enables a user to look into the partial enclosure 221 to determine if a spare battery is present and/or what the current state of charge of the spare battery is by way of status indicator lights.

Operation of the cot loading and unloading system 10 will now be described.

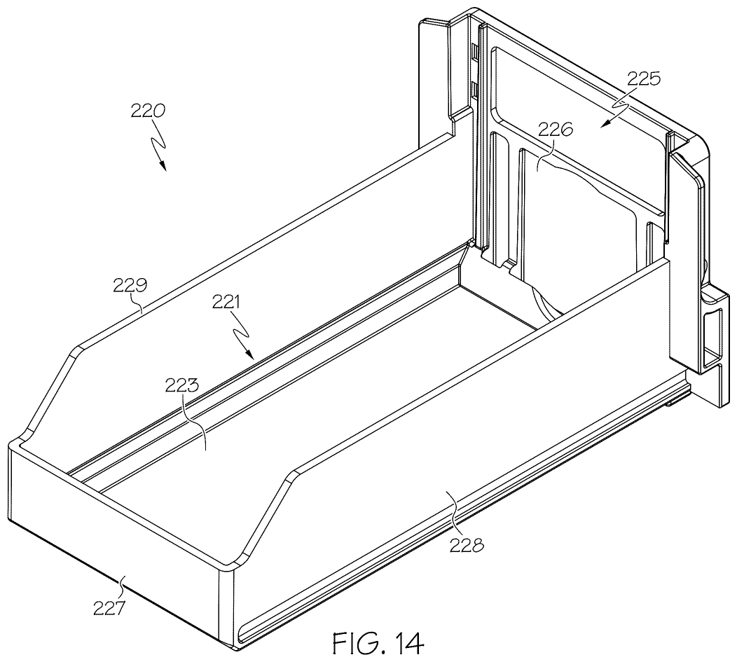

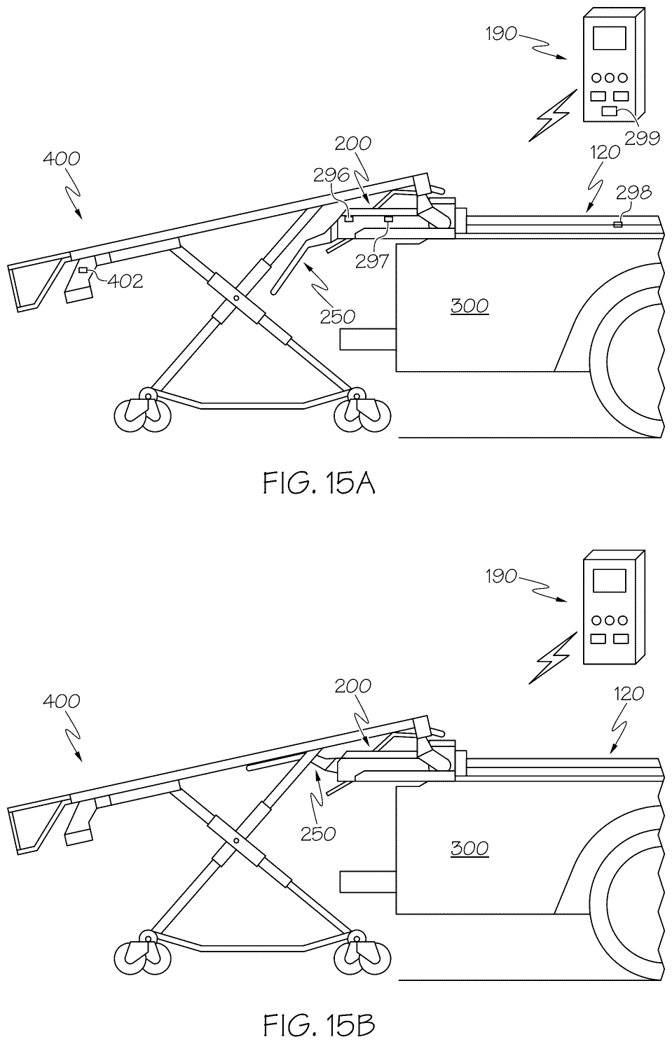

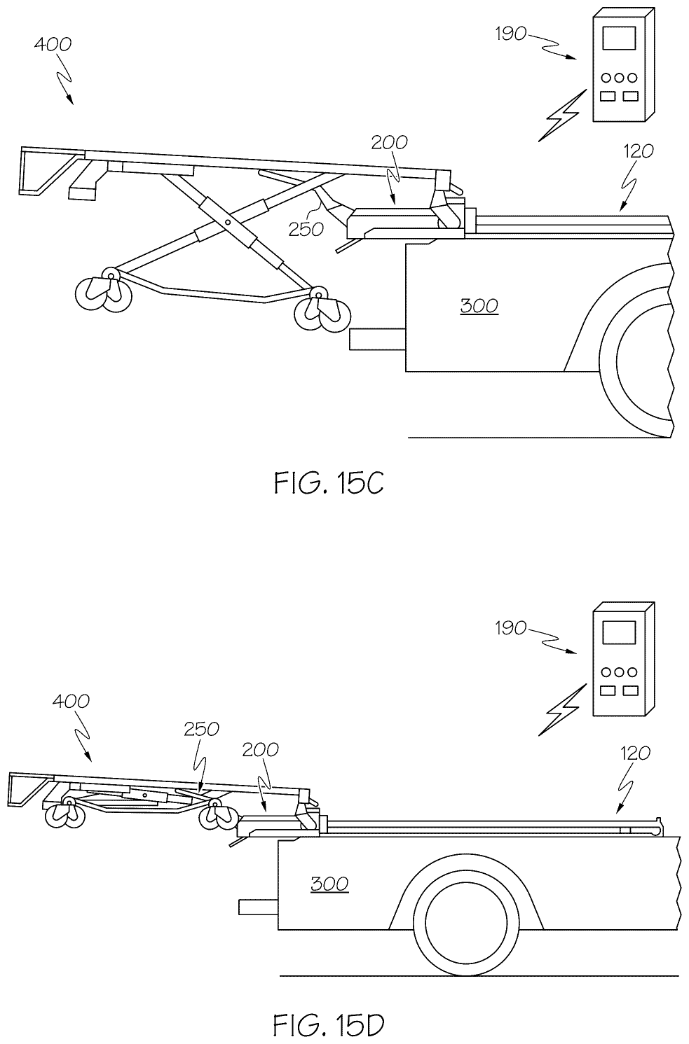

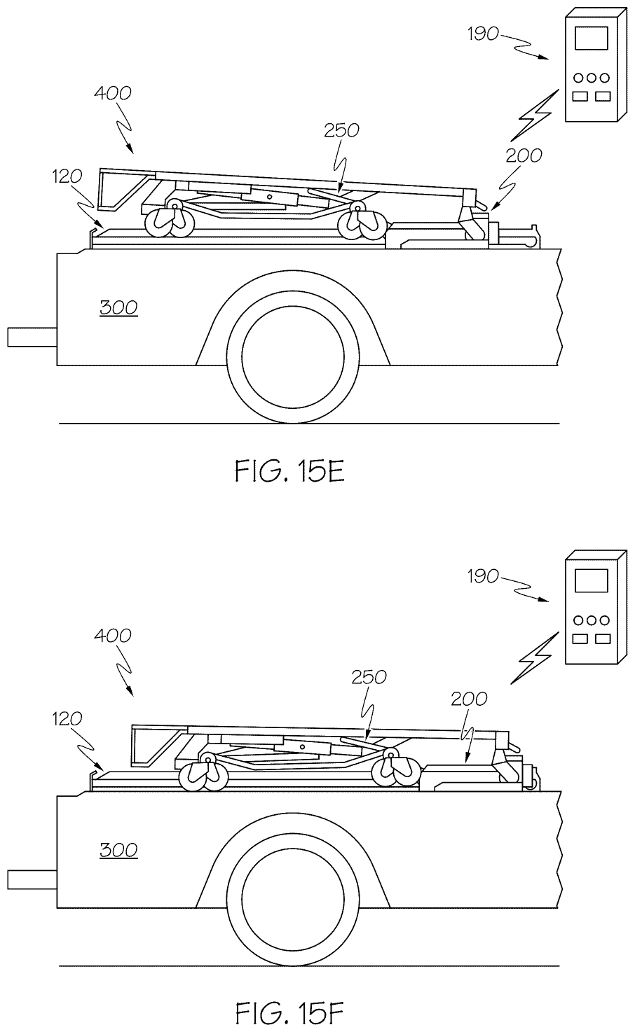

Referring to FIG. 15A, the cot loading and unloading system 10 further includes a master control device 190. The master control device 190 is typically mounted within the emergency vehicle 300 for use by medical personnel. The master control device 190 provides communication between the cot 400 and the cot loading and unloading system 10. Thus, the cot 400 and the cot loading and unloading system 10 are secondary control devices and the master control device 190 is a primary control device. The master control device 190 receives status information from both the cot 400 and the cot loading and unloading system 10, and sends control signals to the cot 400 and/or the cot loading and unloading system 10.

The master control device 190 may include various buttons to provide input, as well as user interface devices, such as an electronic display 340, light emitting diodes, a speaker, and/or the like. The master control device 190 may be configured to provide instruction to medical personnel, provide diagnostic or troubleshooting information, or any other relevant information. The electronic display 340 may display that status information of various components of the cot 400 and the cot loading and unloading system 10.

To start the loading process, the carriage 200 is brought to the foot-end of the fixed rail 120 by using the master control device 190. The load arms 250 of the carriage 200 are in a lowered position. The cot 400 is then wheeled toward the carriage 200 until latching pins on the cot (not shown) are disposed within the receiving slots 242 of the latching mechanisms on both sides of the carriage 200, which causes the latch pawls 244 to lock the latching pins on the cot 400, thereby securing the cot 400 to the carriage 200. Upon locking the latching pawls, the load arms 250 begin to raise automatically until they meet an underside of the litter frame of the cot 400. The cot loading and unloading system 10 is now ready to lift and load the cot 400.

By either pressing a user input control on a local control panel of the cot 400, carriage 200, or the master control device 190, the master control device 190 instructs the load arms 250 to continue to raise, while simultaneously instructing the base of the cot 400 to raise toward the litter frame, thereby collapsing the cot, as shown by FIG. 15C. FIG. 15D illustrates the cot being in a completely collapsed position while being supported by the carriage 200 and the load arms 250. A switch on the cot may be provided to provide feedback that the legs of the cot are fully retracted. It is noted that one or more switches may also be provided on the carriage 200 to provide feedback that the legs of the cot are fully collapsed. For example, as shown best in FIG. 11E, one or more of the load arms 250 may include a cot engagement switch 311 that contacts the legs of the cot when they are fully collapsed. This feedback can be provided to the master control device 190 to signal to the master control device 190 that the legs are fully retracted. The master control device 190 then instructs the carriage 200 to translate back toward a head-end of the fixed rail 120 by way of the drive motor 130, as shown by FIG. 15E. The load arms 250 are then lowered slightly to rest the cot 400 on the floor of the cargo area of the emergency vehicle 300. A fastener extending from the bottom of the cot 400 (not shown) is disposed within the fastener receiver 121, and the carriage lock 131 (FIG. 9) is pushed down by a bottom surface of the carriage 200, and then raised and engaged with a corresponding receiver on the bottom surface of the carriage 200 to lock the carriage 200 to the fixed rail 120. The carriage lock 131 is biased upward by one or more spring members. The fastener of the cot has inwardly biased latches that are pushed outwards engage the receiver to secure the foot-end of the cot 400 to the fixed rail 120. The cot is now secured within the cargo area by the cot loading and unloading system 10.

The process is repeated in reverse to unload the cot 400 from the cargo area of the emergency vehicle 300.

The cot loading and unloading system 10 may be configured to be wirelessly paired with a cot. When there are multiple cots within the vicinity of a cot loading and unloading system 10, it should be determined which cot is the correct cot to wirelessly pair with the cot loading system. In other words, only the cot that is loaded on the cot loading and unloading system 10 should be paired with the cot loading and unloading system 10.

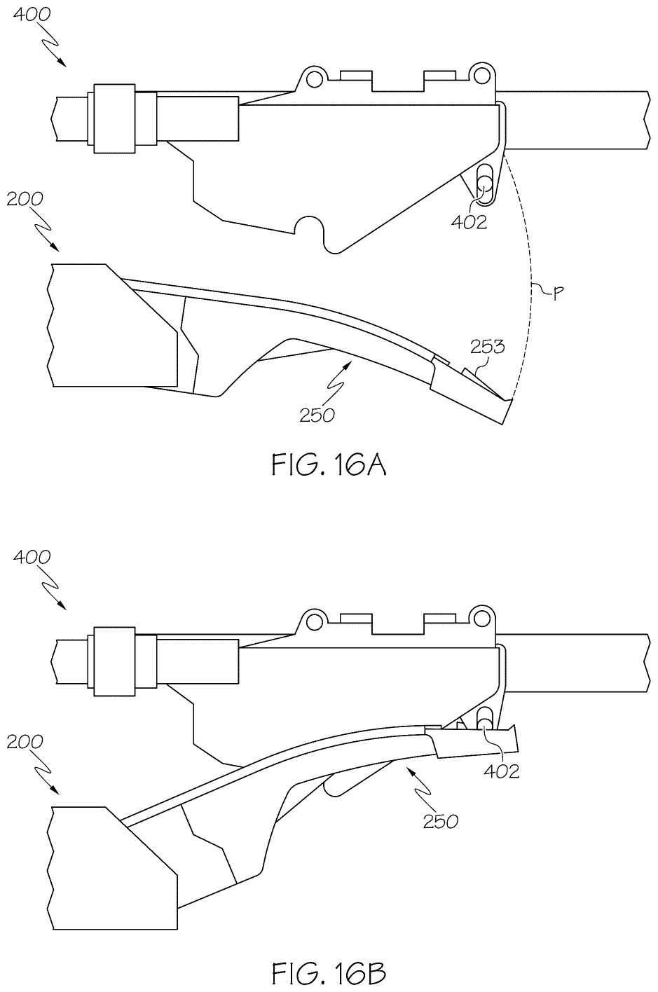

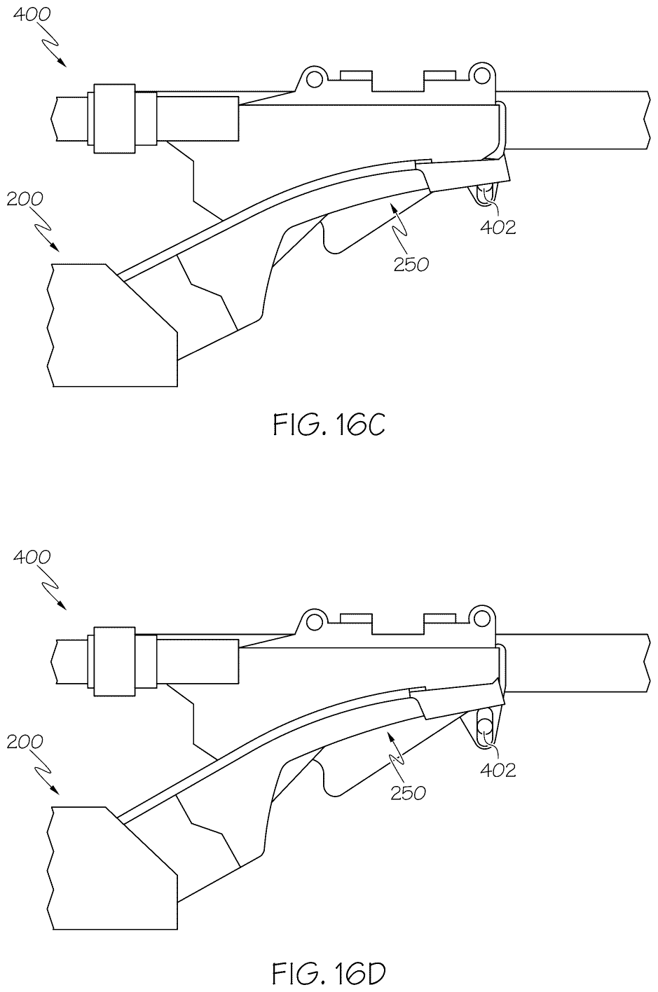

In some embodiments, an ultrasonic sensor 402 is provided on the cot 400 to establish that it is the particular cot that should be paired with the cot loading and unloading system 10. Referring to FIG. 16A, the ultrasonic sensor 402 is positioned at a location having a line of sight of a passing load arm 250 having a travel path P. The load arms 250 further include a switch 253 that closes when the load arm contacts the underside of the litter frame of the cot 400.

The ultrasonic sensor 402 sets a bit (i.e., true/false) within the control system of the cot 400. This information may be wirelessly transmitted via a wireless controller to the master control device 190, which stores the information.

The cot loading and unloading system 10 communicates with the master control device 190, and can therefore retrieve information on the current status of a specific cot that is paired or attempting to pair with the cot loading and unloading system 10, and determine next steps in the operational flow.

When a cot 400 is latched into the latch mechanisms 240 of the carriage 200, the load arms 250 of the carriage 200 ascend upwards to meet the cot 400. As the load arms 250 approach contact with the cot 400, they will pass the ultrasonic sensor 402, as shown by FIG. 16B. The ultrasonic sensor 402 is strategically placed such that it first detects upper edge of the load arm 250 and then, as the load arms 250 continue up, the ultrasonic sensor 402 sees the bottom edge of the load arm 250, as shown by FIG. 16C. Once the load arms 250 pass the ultrasonic sensor as shown by FIG. 16D, they come into contact with the cot and activate the switches 252 within the load arms 250. This sequence of events is used to pair the proper cot with the cot loading and unloading system 10 via the master control device 190, and establish communication between the cot loading and unloading system 10 and the cot 400 via the master control device 190 going forward.

Table 1 below illustrates an example mode of operation for pairing a cot with the cot loading and unloading system 10.

TABLE 1
Pairing Process

| | | Ultrasonic Sensor | Pairing |
|---|---|---|---|
| Cot Status | Loader Status | Logic Status | Status |
| Latched into Loader | Load Arms begin | False/‘0’ | Not Paired |
| Latches | Ascent | | |
| Waiting for Pairing | Load Arms Upper | True/‘1’ | Not Paired |
| to Complete | Edge in Ultrasonic | | |
| | Detection Region | | |
| Waiting for Pairing | Load Arms Lower | True/‘1’ | Not Paired |
| to Complete | Edge in Ultrasonic | | |
| | Detection Region | | |
| Waiting for Pairing | Load Arms Leave | False/‘0’ | Not Paired |
| to Complete | Ultrasonic Detection | | |
| | Region | | |
| Paired with Loader - | Load Arm Contact | False/‘0’ | Paired |
| Ready to Load | Switches Activated | | |

In some embodiments, the cot pairing system utilizes wireless communication microcontrollers (referred to herein as “wireless chip” or “wireless chips”) rather than an ultrasonic sensor. Referring once again to FIG. 15A, the cot 400 has a wireless chip 402, the carriage 200 has a wireless chip 297, the fixed rail has a wireless chip 298, and the master controller 190 has a wireless chip 299. It is noted that the locations of the wireless chips in FIG. 15A are provided for illustrative purposes only, and that the wireless chips may be positioned on or within the fixed rail 120 and the carriage 200 at any locations. As a non-limiting example, each chip may be an ESP microcontroller manufactured by Espressif Systems.

Using the wireless chips 402, 297, 298 and 299, the master controller device 190 can detect the wireless signals of wireless chips on the cots that are present within a certain radius of the fixed rail 120, such as 50 feet as a non-limiting example. The communications described below are performed using the wireless chips 402, 297, 298 and 299 shown in FIG. 15A.

In a first (1) step of the pairing sequence, the carriage 200 sends a message to the master controller 190 that a cot has been locked to it. In response, the master controller 190 wirelessly sends a broadcast address in step two (2). All cots within the receiving area receive this broadcast address and respond with their MAC addresses to the master controller 190 by way of their own broadcast addresses using the wireless chips 402 in step three (3).

At step four (4) the carriage 200 receives all RSSI (signal strength) values from the broadcast addresses of the cots within the receiving area. The master controller 190 then receives all observed RSSI values from the carriage 200 at step five (5). At step six (6), the carriage 200 then sends a signal to the fixed rail 120 that it is done sending signal strength values to the master controller. The fixed rail 120 repeats steps (1)-(6) performed by the carriage 200 such that both the fixed rail 120 and the carriage 200 poll all cots within the receiving area. Finally, at step eight (8) the master controller 190 analyzes the RSSI values provided by the carriage 200 and the fixed rail 120 and decides which cot to pair with based on signal strength such that the cot returning the largest RSSI values from the carriage 200 and the fixed rail 120 is selected for pairing. It should be understood that in some embodiments only fixed rail 120 or the carriage 200 report RSSI values to the master controller 190.

The carriage 200 and the fixed rail 120 only wirelessly receives signals from the cots for the purpose of determining strength signals and reporting them to the master controller 190. The carriage 200 and the fixed rail 120 do not receive wireless signals from the cots for the purpose of controlling any mechanisms of the carriage 200 and/or the fixed rail 120.

In some embodiments, additional information other than signal strength values may be utilized to select the appropriate cot for pairing. For example, information such as cot leg state (collapsed or retracted) and recent cot inputs may be used. A cot having fully collapsed legs that is in the vicinity of the cot loading and unloading system 10 is not likely the cot to be paired so it may be filtered, further improving the ability for the master controller 190 to be paired with the correct cot.

A description of the communication scheme between the master controller 190, the carriage 200, fixed rail 120 and the cot 400 in various states is provided below.

### State 1: Carriage at Home Position

The carriage 200 is in the home position when it is fully retracted into the cargo area of the ambulance. The statuses of the carriage 200 and the fixed rail 120 components of the are provided to the master controller 190 in this state.

### State 2: Rail Release Button Pressed

When a user presses the release button 113 at the end of the fixed rail 120, the load arms 250 of the carriage 200 raise, the carriage 200 is unlocked from the fixed rail 120, and the carriage 200 drives slightly forward.

### State 3: Carriage Out, No Cot

In this state, the user can either use the master controller 190 buttons or the side buttons on the carriage 200 to drive the carriage 200 out of the ambulance to the end of the fixed rail 120. At this point there is no cot paired with the master controller 190. When the carriage 200 reaches the end of the fixed rail 120, the load arms 250 automatically go down due to a signal resulting from contact between a switch on the fixed rail 120 and the carriage lock lever 262 (FIG. 11C) on the carriage 200. In this state the carriage 200 is ready to receive a cot.

### State 4: Cot Locked to Carriage

When a cot 400 is properly loaded onto the carriage 200, the latch mechanisms 240 latch on pins of the cot 400, which initiates automatic raising of the load arms 250 of the carriage 200 (see FIGS. 15B and 15C).

Additionally, the carriage 200 sends a wireless message to the master controller 190. This wireless message indicates to the master controller 190 that a cot 400 has been locked to the carriage 200. The master controller 190 then produces a broadcast address for pairing purposes as described above. Only pairing-compatible cots may be paired according to the wireless communication process. For any other non-pairing-compatible cot, there is no pairing routine and thus requires user manual manipulation of buttons.

### State 5: Carriage Automatic Arm Raise

As stated above, once the latch mechanisms 240 latch on pins of the cot 400, the load arms 250 of the carriage 200 automatically raise. The load arms 250 automatically stop raising once they contact the frame of the cot. No sensor is used to detect contact between the arms and the cot. Rather, a microcontroller 296 (FIG. 15A) of the carriage 200 directly measures a load arm current of the actuator 277 (FIG. 13D) as the load arms 250 move. If the current changes, such as exceeding a predetermined threshold, the carriage 200 instructs the actuator 277 to stop raising the load arms 250, and sends a message to the master controller 190. The load arm current increases when the load arms 250 contact the cot 400. The master controller 190 may also monitor changing actuator status during this time.

After the load arms 250 stop upon contact with the cot 400, the master controller 190 determines the next step based on cot loading and unloading system 10 and cot 400 inputs.

### State 6: Cot Legs Up, Load Arms Up

The user will manipulate buttons on the cot 400, the master controller 190, or the side of the carriage 200 to drive the legs of the cot 400, the load arms of the carriage 200, or the carriage 200 along the fixed rail 120. In all cases, the signal generated by the (+/−) buttons on the cot 400 and/or the carriage 200 are passed to the master controller 190 for it to produce the appropriate output signals to the cot 400 and components of the cot loading and unloading system 10. For example, pressing the (−) button on the cot 400 does not automatically move the legs of the cot 400. Rather, the signal is provided to the master controller 490 for it to determine the appropriate movement of the cot legs, the load arms 250, or the carriage 200 along the rail. Thus, all control is provided by the master controller 190.

When the user presses the (−) button on a newly locked cot 400, the master controller 190, or the carriage 200, the load arms 250 are first raised to lift the cot 400. Then the legs of the cot 400 are retracted up. Continually pressing the (−) button after the legs are fully retracted causes the carriage 200 to move in a direction toward the home position (i.e., the head-end of the fixed rail 120) within the cargo area of the ambulance. In all cases, the master controller 190 receives inputs from the cot 400, the carriage 200 and the fixed rail 120, and produces control signals to control the movement of the cot 400 and the carriage 200.

### State 8: Other State—Cot Locked, Load Arms Down

In this state, the cot's legs are deployed and the latch mechanisms 240 of the carriage 200 are locked to the pins of the cot. The cot 400 is wirelessly paired with the master controller 190. A (−) button signal input to the master controller 190 (either by the cot 400, the master controller 190, or the carriage 200) will only raise the load arms 250 up. The master controller 190 will not allow the cot's legs to retract. The cot's legs will not start retracting until the master controller 190 sends the command to the carriage 200 to actuate the load arms 250 to pick up and support the cot.

### State 9: Other State—Cot Docked, Carriage in Home Position, Charging System Engaged

In this state, the cot 400 and the carriage 200 are both in the home position within the cargo area of the ambulance. Both the carriage and cot charging connections are engaged, and the batteries are charging. To drive the cot 400 and the carriage 200 out, the user may press a button on the cot 400, the master controller 190, or the carriage 200 (e.g., the (+) button), which causes the carriage 200 to drive in a direction toward the end of the fixed rail 120 and out of the cargo area. The user can continue to press the button to extend the legs and lower the arms so that the cot 400 is once again supported by the ground.

### Communication Scheme

In states 1 through 3 above, the master controller 190 is paired with the cot loading and unloading system 10 and collects the following information from the cot loading and unloading system 10:
Battery information of the cot loading and unloading system.
Status update of the cot loading and unloading system including position and environmental light status
Serial number of the cot loading and unloading system
Cycle count of the cot loading and unloading system
Errors of the cot loading and unloading system

In states 4 through 6 above, the master controller 190 is paired with both a cot 400 and the cot loading and unloading system 10. All signals from the cot 400 are transmitted only to the master controller 190 through wireless communication. The master controller 190 commands both the cot 400 and the cot loading and unloading system 10 regarding what actions to perform next based on the inputs it receives.

The master controller collects 190 the following information from the cot 400:
Battery information of the cot
Errors of the cot
MAC address for the cot to use in pairing.
Serial number of the cot
Cycle count of the cot
Motor commands of the cot legs extension and retraction
Environmental light and actuator status of the cot

The master controller 190 transmits the following to the cot 400:
Mac address of the master controller to use in pairing
Latch mechanism status
Environmental light status
Motor commands of the cot legs extension and retraction

The master controller 190 collects the following information from the cot loading and unloading system 10:
Battery information of the cot loading and unloading system.
Status update of the cot loading and unloading system including position and environmental light status.
Serial number of the cot loading and unloading system
Cycle count of the cot loading and unloading system
Errors of the cot loading and unloading system

The master controller 190 transmits the following to the cot loading and unloading system 10:
Motor commands for loading and unloading purposes
Environmental light and actuator status of the cot

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A cot loading and unloading system comprising:
a fixed rail comprising a track, wherein the fixed rail is operable to be fixed to a floor; and
a carriage directly coupled to the track and operable to travel along the fixed rail on the track, wherein the carriage is further operable to travel to an extended position such that at least a portion of the carriage extends beyond a length of the fixed rail.

2. The cot loading and unloading system of claim 1, wherein the track comprises a rack member operable to receive a drive pinion of the carriage.

3. The cot loading and unloading system of claim 1, wherein:
the fixed rail further comprises an end roller support section comprising safety hook, a foot-end roller, and a foot-end vertical roller; and
the foot-end roller and the foot-end vertical roller are operable to support a support beam disposed in a passageway of the fixed rail.

4. The cot loading and unloading system of claim 3, wherein the fixed rail further comprises a central vertical roller to assist the support beam in translating within the passageway of the fixed rail.

5. The cot loading and unloading system of claim 1, wherein:
the track comprises a first side, a second side, a rack member, a wheel guide member, and at least two guide members;
the at least two guide members are disposed in opposing grooves in the second side of the track;
the first side comprises a first groove and a second groove opposing the first groove;
the rack member is positioned in the first groove and the wheel guide member is positioned in the second groove; and
the rack member comprises a rack protrusion and the wheel guide member comprises a wheel guide protrusion.

6. The cot loading and unloading system of claim 1, further comprising a support beam slidably disposed within a passageway of the fixed rail, wherein:
the fixed rail further comprises:
a base plate; and
a first ramp block and a second ramp block mounted on the base plate;
the first ramp block defines a first detent having a first detent switch and the second ramp block defines a second detent having a second detent switch and a third detent having a third detent switch;
the first detent, the second detent and the third detent are operable to receive a swing bar roller of the support beam; and
the first detent switch, the second detent switch and the third detent switch are operable to be activated by the swing bar roller to establish a position of the support beam relative to the fixed rail.

7. The cot loading and unloading system of claim 1, further comprising a support beam disposed within a passageway of the fixed rail, wherein the support beam is operable to translate within the passageway and support the carriage when it is in the extended position.

8. The cot loading and unloading system of claim 1, wherein:
the fixed rail further comprises:
a fastener receiver for locking a fastener of the cot to the fixed rail; and
a carriage lock for locking the carriage to the fixed rail; and
the carriage further comprises a pair of latch mechanisms for locking a head-end of the cot to the carriage.

9. The cot loading and unloading system of claim 8, wherein the fixed rail further comprises a release that is operable to unlock the carriage lock.

10. The cot loading and unloading system of claim 8, further comprising a support beam disposed within a passageway of the fixed rail, the support beam comprising:
a support beam member; and
an end block coupled to an end of the support beam member, the end block comprising an unlock button,
wherein:
the support beam is operable to translate within the passageway and support the carriage when it is in the extended position; and
the unlock button is operable to unlock the carriage lock and the fastener receiver when the cot loading and unloading system is in a first mode; and
the unlock button is operable to unlock the pair of latch mechanisms and the fastener receiver when the cot loading and unloading system is in a second mode.

11. The cot loading and unloading system of claim 8, wherein:
the fixed rail further comprises a removable section at a foot-end of the fixed rail;
the cot loading and unloading system is in the first mode when the removable section is present at the foot-end of the fixed rail; and
the cot loading and unloading system is in the second mode when the removable section is removed from the foot-end of the fixed rail.

12. The cot loading and unloading system of claim 11, further comprising a release rod, wherein:
the end block further comprises:
a flipper coupled to the unlock button and the release rod; and
a position lever comprising a rocker tab, wherein the rocker tab contacts the flipper;
when the removable section is present on the fixed rail, the removable section presses on the position lever causing the rocker tab to press on the flipper, which further causes the release rod to be rotated in a first direction; and
when the removable section is removed from the foot-end of the fixed rail and the support beam member is extended beyond a top plate of the fixed rail, the position lever moves in a direction away from a base plate of the fixed rail which lifts the rocker tab away from the flipper and causes the release rod to be rotated in a second direction.

13. The cot loading and unloading system of claim 12, wherein:
the support beam comprises:
a flip-flop plate comprising a flip-flop recess; and
a flip-flop tab coupled to the release rod and disposed within the flip-flop plate;
when the release rod is rotated in the first direction, the flip-flop tab is raised and out of the flip-flop recess; and
when the release rod is rotated in the second direction, the flip-flop tab is lowered and disposed within the flip-flop recess.

14. The cot loading and unloading system of claim 13, wherein the fixed rail further comprises:
a first linkage assembly comprising a plurality of primary links, a first input arm and a first output arm, wherein the first input arm is operable to contact the flip-flop tab when the release rod is rotated in the first direction; and
a second linkage assembly comprising a plurality of secondary links, a second input arm and a second output arm, wherein the second input arm is operable to contact the flip-flop tab when the release rod is rotated in the first direction.

15. The cot loading and unloading system of claim 14, wherein:
the fixed rail further comprises a switch plate assembly comprising:
a switch plate base comprising a first opening and a second opening such that the first input arm of the first linkage assembly is disposed within the first opening and the second input arm of the second linkage assembly is disposed within the second opening;
an intermediate slider slidably disposed within the switch plate base and coupled to the first input arm;
a fastener slider slidably disposed within the switch plate base and contacting the intermediate slider;
a latch slider slidably disposed within the switch plate base and contacting the fastener slider; and
a carriage slider slidably disposed within the switch plate base, coupled to the intermediate slider, and operable to contact the latch slider.

16. The cot loading and unloading system of claim 15, wherein the fixed rail further comprises:
a fastener link arm coupled to the fastener slider and operable to manipulate the fastener receiver;
a carriage link arm coupled to the carriage slider and operable to manipulate the carriage lock; and
a latch link arm coupled to the latch slider and operable to manipulate the pair of latch mechanisms.

17. The cot loading and unloading system of claim 16, wherein when the cot loading and unloading system operates in the first mode:
the release rod is rotated in the first direction and the flip-flop tab is proximate the first input arm of the first linkage assembly; and
when next the unlock button is pressed:
the release rod is pushed in a direction toward a head-end of the fixed rail;
the flip-flop tab contacts and pushes the first input arm in a direction toward the head-end of the fixed rail;
the first output arm pushes the intermediate slider toward the foot-end of the fixed rail;
the intermediate slider pushes the fastener link arm to unlock the fastener receiver;
the intermediate slider pulls the carriage slider; and
the carriage slider pulls the carriage link arm to unlock the carriage lock.

18. The cot loading and unloading system of claim 16, wherein:
when the removable section is removed from the fixed rail the release rod is rotated in the second direction and the flip-flop tab is disposed in the flip-flop recess;
when next the support beam is pushed in a direction toward, the head-end of the fixed rail the flip-flop tab passes under the first input arm toward the second input arm; and
when next the support beam is fully positioned under the top plate of the fixed rail, the cot loading and unloading system operates in the second mode.

19. The cot loading and unloading system of claim 16, wherein when the cot loading and unloading system operates in the second mode:
the release rod is rotated in the first direction and the flip-flop tab is proximate the second input arm of the first linkage assembly;
when next the unlock button is pressed:
the release rod is pushed in a direction toward a head-end of the fixed rail;
the flip-flop tab contacts and pushes the second input arm in a direction toward the head-end of the fixed rail;
the second output arm pushes the latch slider toward the foot-end of the fixed rail; and
the latch slider pushes the fastener link arm to unlock the fastener receiver and pulls the latch link arm to unlock the pair of latch mechanisms.

20. A fixed rail of a cot loading and unloading system comprising a track further comprising a first side, a second side, a rack member, and a wheel guide member, wherein:
the fixed rail is operable to be fixed to a floor;
the rack member comprises a plurality of teeth and a rack protrusion;
the wheel guide member comprises a wheel guide protrusion;
the rack protrusion and the wheel guide protrusion oppose one another to receive at least one wheel of a carriage; and
the rack protrusion and the wheel guide protrusion have a profile to mate with a groove of the at least one wheel.
